(19) United States
(12) Patent Application Publication
(10) Pub. No.: US 2020/0372439 A1
(43) Pub. Date: Nov. 26, 2020

(54) SYSTEMS AND METHODS FOR ORGANIZING PARTICIPANTS OF SERVICE PLATFORM

(71) Applicant: BEIJING DIDI INFINITY TECHNOLOGY AND DEVELOPMENT CO., LTD., Beijing (CN)

(72) Inventors: Lingyu ZHANG, Beijing (CN); Lin ZENG, Beijing (CN); Ning MA, Beijing (CN); Bo LIU, Beijing (CN); Xiaoxue WANG, Beijing (CN); Chen CHEN, Beijing (CN)

(73) Assignee: BEIJING DIDI INFINITY TECHNOLOGY AND DEVELOPMENT CO., LTD., Beijing (CN)

(21) Appl. No.: 16/990,973

(22) Filed: Aug. 11, 2020

Related U.S. Application Data
(63) Continuation of application No. PCT/CN2019/074696, filed on Feb. 3, 2019.

(30) Foreign Application Priority Data
Feb. 11, 2018 (CN) 201810141843.1
May 23, 2018 (CN) 201810499757.8
Jun. 11, 2018 (CN) 201810596480.0

(51) Int. Cl. G06Q 10/06

(52) U.S. Cl. CPC G06Q 10/063118; G06Q 10/06315

(57) ABSTRACT

A system and method for determining a team are provided. The method may include obtaining information relating to each of a plurality of participants to be grouped, the plurality of participants including a plurality of team leaders and a plurality of team members. The method may also include determining one or more teams by automatically allocating the plurality of team members to the plurality of team leaders based on the information relating to the plurality of participants, wherein each of the one or more teams includes a team leader and at least one team member.

### CROSS-REFERENCE TO RELATED APPLICATIONS

This application is a continuation of International Application No. PCT/CN2019/074696 filed on Feb. 3, 2019, which further claims priority of Chinese Application No. 201810141843.1 filed on Feb. 11, 2018, Chinese Application No. 201810499757.8 filed on May 23, 2018, and Chinese Application No. 201810596480.0 filed on Jun. 11, 2018, the entire contents of each of which are hereby incorporated by reference.

### TECHNICAL FIELD

The present disclosure generally relates to an online to offline service platform, and in particular, relates to systems and methods for organizing participants of an online to offline service platform.

### BACKGROUND

With the continuous development of the Internet economy, there are more and more Internet-based services, e.g., online car-hailing service, food delivery, express delivery, substitute driving, etc. Take the online car-hailing service as an example. Online car-hailing is also referred to as the online taxi reservation. A passenger can request for a taxi through the passenger terminal at any time and any place. A driver can accept an order for taxi nearby, and after the driver accepts the order, he or she will pick up the passenger at the agreed upon location. A passenger does not need to wait passively for taxis passing by and can instead take the initiative to submit an order via an online car-hailing service so that a driver accepting the order can come and pick up the passenger, thereby facilitating the passenger's traveling.

At present, in order to obtain more users, an online car-hailing platform needs to increase the capacity of the online car-hailing platform, a driver who has reached a set number (or count) of orders will be rewarded in order to increase the driver's incentive for taking orders through the online car-hailing platform. However, after the driver reaches the set number (or count) of orders, when drivers work alone, most drivers would be satisfied with the rewards they can get. The effect of the existing incentives would not be sufficient, and the capacity of the online car-hailing platform would decrease.

In addition, since the drivers work alone, each driver has his/her own behavioral habits, their willingness to accept orders would be low, especially because of rain or snow weather, remote areas, or certain time periods (such as morning and evening peak hours), etc. Therefore, the operation of the online car-hailing platform would also be affected, which may also lead to uneven transportation resources and affect passengers' travel experience. By organizing drivers into teams, the drivers can be encouraged to complete more orders by mutual encouragement between the drivers and competition with other driver teams. However, the prior art usually adopts an offline approach for organizing teams, which may be inconvenient.

### SUMMARY

In one aspect of the present disclosure, a system is provided. The system may include at least one storage medium including a set of instructions for determining a team and at least one processor in communication with the at least one storage medium. When executing the set of instructions, the at least one processor is directed to perform operations including: obtaining information relating to each of a plurality of participants to be grouped, the plurality of participants including a plurality of team leaders and a plurality of team members; and determining one or more teams by automatically allocating the plurality of team members to the plurality of team leaders based on the information relating to the plurality of participants, wherein each of the one or more teams includes a team leader and at least one team member.

In some embodiments, to determine the one or more teams, the at least one processor may be directed to additional operations including: determining an acceptance probability between each of the plurality of team leaders and each of the plurality of team members based on the information relating to the plurality of participants; determining a team recommendation scheme based on the acceptance probabilities using an optimization recommendation algorithm; and determining the one or more teams based on the team recommendation scheme.

In some embodiments, to determine the acceptance probability between each of the plurality of team leaders and each of the plurality of team members, the at least one processor may be directed to perform additional operations including: determining the acceptance probability between each of the plurality of team leaders and each of the plurality of team members based on the information relating to the plurality of participants using an acceptance probability model.

In some embodiments, the acceptance probability model may be determined based on historical team determination data relating to the plurality of team leaders and the plurality of team members.

In some embodiments, the acceptance probability model may be determined using a logistic regression algorithm.

In some embodiments, to determine the team recommendation scheme based on the acceptance probabilities using the optimization recommendation algorithm, the at least one processor may be further directed to perform additional operations including: determining an expected success probability of determining a team for each of one or more candidate team recommendation schemes; and designating the candidate team recommendation scheme corresponding to the maximum expected success probability among the one or more candidate team recommendation schemes as the team recommendation scheme.

In some embodiments, to determine the team recommendation scheme based on the acceptance probabilities using the optimization recommendation algorithm, the at least one processor may be further directed to perform additional operations including: determining an expected success probability model for determining a team; and determining the team recommendation scheme based on the expected success probability model using the optimization recommendation algorithm.

In some embodiments, to determine the one or more teams, the at least one processor may be directed to perform additional operations including: determining a matching value between each of the plurality of team leaders and each of the plurality of team members based on the information relating to the plurality of team leaders and the plurality of team members; and determining the one or more teams based on the matching values.

In some embodiments, to determine the matching value between each of the plurality of team leaders and each of the plurality of team members, the at least one processor may be directed to perform additional operations including: determining a similarity degree between the information of the each of the plurality of team leaders and the information of the each of the plurality of team members; and determining the matching value between each of the plurality of team leaders and each of the plurality of team members based on the similarity degree between the information of the each of the plurality of team leaders and the information of the each of the plurality of team members.

In some embodiments, the similarity degree may include a hometown similarity degree, an age similarity degree, and a character similarity degree.

In some embodiments, the hometown similarity degree may be determined based on a hometown evaluation function, the age similarity degree may be determined based on an age evaluation function, and the character similarity degree is determined based on a character evaluation function.

In some embodiments, to determine the matching value, the at least one processor may be directed to perform additional operations including: determining a first sub-matching value based on the hometown similarity degree; determining a second sub-matching value based on the age similarity degree; determining a third sub-matching value based on the character similarity degree; and determining the matching value based on at least one of the first sub-matching value, the second sub-matching value, or the third sub-matching value.

In some embodiments, to determine the one or more teams, the at least one processor may be directed to perform additional operations including: extracting evaluation information relating to the plurality of participants from the information relating to the plurality of participants to be grouped; assigning, based on the evaluation information relating to each of the plurality of participants, each of the plurality of participants to a group; and determining the one or more teams based on the group assignment relating to each of the plurality of participants.

In some embodiments, to assign each of the plurality of participants to a group, the at least one processor may be directed to perform additional operations including: obtaining a classification model; and determining the group assignment relating to each of the plurality of participants based on the evaluation information using the classification model.

In some embodiments, the evaluation information relating to a participant of the plurality of participants may include evaluation information of the participant on the online to offline service platform.

In some embodiments, the groups may include a recommender group, a passive person group, and a detractor group, and to assign each of the plurality of participants to a group, the at least one processor may be directed to perform additional operations including: assigning the participant to the recommender group, the passive person group, or the detractor group based on the evaluation information of the participant on the online to offline service platform.

In some embodiments, the evaluation information relating to a participant of the plurality of participants may include evaluation information that a service requestor provides regarding the participant.

In some embodiments, the groups may include a high-quality service group, a general-quality service group, and a poor-quality service group, and to assign each of the plurality of participants to a group, the at least one processor may be directed to perform additional operations including: assigning the participant to the high-quality service group, the general-quality service group, or the poor-quality service group based on the valuation information that the service requestor provides regarding the participant.

In some embodiments, the at least one processor may be directed to perform additional operations including: organizing one or more participants belonging to different groups into a team.

In some embodiments, the at least one processor may be directed to perform additional operations including: organizing one or more participants belonging to a same group into a team.

In some embodiments, to determine the one or more teams, the at least one processor may be directed to perform additional operations including: extracting historical order information relating to each of the plurality of participants from the information relating to the plurality of participants to be grouped; determining a driving behavior characteristic for each of the plurality of participants based on the historical order information relating to the each participant; dividing the plurality of participants into one or more driver groups based on the driving behavior characteristic of each of the plurality of participants; and for each of the one or more driver groups, forming at least one team.

In some embodiments, the driving behavior characteristic of a participant may include a working time of the participant or a driving region of the participant.

In some embodiments, to divide the plurality of participants into one or more driver groups, the at least one processor may be directed to perform additional operations including: determining a driving behavior similarity degree between each pair of the plurality of participants; and determining the one or more driver groups based on the driving behavior similarity degree between each pair of the plurality of participants.

In some embodiments, each of the driver group may include at least one team leader and at least one team member, and to form at least one team for each of the one or more driver groups, the at least one processor may be directed to perform additional operations including: for a driver group, sending information relating to the at least one team member of the driver group to the at least one team leader of the driver group; receiving a response from the at least one team leader of the driver group with respect to each of the at least one team member of the driver group; and determining the at least one team for the driver group based on the response from the at least one team leader of the driver group.

In some embodiments, the information relating to the at least one team member and the response may be encrypted, and the at least one processor may be further directed to perform additional operations including: decrypting the encrypted information relating to the at least one team member and decrypting the encrypted response.

In some embodiments, to decrypt the encrypted information relating to the at least one team member, the at least one processor may be further directed to perform additional operations including: verifying authentication information of the at least one team member or a device of the at least one team member before the decrypting of the encrypted information, and to decrypt the encrypted response, the at least one processor may be further directed to perform additional operations including: verifying authentication information of the at least one team leader or a device of the at least one team leader before the decrypting of the encrypted response.

In some embodiments, the at least one processor may be further directed to perform additional operations including: receiving a registration instruction via a first interface of a device of a participant of the plurality of the participants to be grouped; determining a type of the registration instruction, wherein the type of the registration instruction includes a leader registration instruction or a member registration instruction; and in response to a determination that the registration instruction is a leader registration instruction, identifying, from the plurality of participants, one or more candidate team members; causing user information relating to the one or more candidate team members to be displayed on a second interface of the device of the participant; and receiving a selection of at least one of the one or more candidate team members from the device of the participant; sending a first invitation for joining a team to each of the at least one selected candidate team member; receiving one or more responses to the first invitation; determining, based on the received responses, at least one team member that agrees to join the team; and causing user information relating to the at least one team member that agrees to join the team to be displayed on a third interface of the device of the participant.

In some embodiments, the at least one processor may be further directed to perform additional operations including: encrypting the first invitation; and sending the encrypted first invitation to each of the at least one selected candidate team member.

In some embodiments, the encrypted first invitation sent to each of the at least one selected candidate team member may include authentication information of the each selected candidate team member or authentication information of a device of the selected candidate team member to authenticate the selected candidate team member or the device of the each selected candidate team member.

In some embodiments, to determine one or more candidate team members, the at least one processor may be directed to perform additional operations including: causing the device to display a personal information setting interface; receiving user information set by the participant through the personal information setting interface; and determining the one or more candidate team members based on the user information set by the participant and the leader registration instruction.

In some embodiments, the at least one processor may be directed to perform additional operations including: determining a count of the at least one team member that agrees to join the team; and in response to a determination that the count of the at least one team member that agrees to join the team is equal to or exceeds a predetermined value, generating a notification indicating the team has been formed successfully; sending the notification to each of the at least one team member; and causing the notification to be displayed on the third interface of the devices.

In some embodiments, the at least one processor may be further directed to perform additional operations including: encrypting the notification; and sending the encrypted notification to each of the at least one team member.

In some embodiments, the encrypted notification sent to a team member may include authentication information of the team member or authentication information of the device of the team member to authenticate the team member or the device of the team member.

In some embodiments, in response to a determination that the registration instruction is a member registration instruction, the at least one processor may be directed to perform additional operations including: causing the device to display a personal information setting interface; receiving user information set by the participant through the personal information setting interface; identifying, from the plurality of participants, a team leader for the participant based on the user information of the participant; and detecting that a second invitation is received from the team leader; and causing the second invitation to be displayed on a fourth interface of the device.

In some embodiments, the second invitation may be encrypted, and the at least one processor may be further directed to perform additional operations including: decrypting the encrypted second invitation.

In some embodiments, to decrypt the encrypted second invitation, the at least one processor may be further directed to perform additional operations including: verifying authentication information of the team member or the device of the team member before the decrypting.

In some embodiments, the at least one processor may be further directed to perform additional operations including: causing activity information corresponding to the type of the registration instruction to be displayed on a fifth interface of the device, wherein the activity information includes at least one of responsibility information, task information, or reward information.

In another aspect of the present disclosure, a method is provided. The method may be implemented on a computing device having at least one processor and at least one storage medium including a set of instructions for determining a team. The method may include obtaining information relating to each of a plurality of participants to be grouped, the plurality of participants including a plurality of team leaders and a plurality of team members. The method may also include determining one or more teams by automatically allocating the plurality of team members to the plurality of team leaders based on the information relating to the plurality of participants, wherein each of the one or more teams includes a team leader and at least one team member.

In yet another aspect of the present disclosure, a non-transitory computer-readable storage medium may embody a computer program product. The computer program product may include instructions configured to cause a computing device to perform a method. The method may include obtaining information relating to each of a plurality of participants to be grouped, the plurality of participants including a plurality of team leaders and a plurality of team members. The method may also include determining one or more teams by automatically allocating the plurality of team members to the plurality of team leaders based on the information relating to the plurality of participants, wherein each of the one or more teams includes a team leader and at least one team member.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an exemplary online to offline service system according to some embodiments of the present disclosure;

FIG. 2 is a block diagram of an exemplary computing device configured to implement a specific system disclosed in the present disclosure;

FIG. 3A is a block diagram illustrating an exemplary user terminal according to some embodiments of the present disclosure;

FIG. 3B is a block diagram illustrating another exemplary user terminal according to some embodiments of the present disclosure;

FIG. 4 is a block diagram illustrating an exemplary processing engine according to some embodiments of the present disclosure;

FIG. 5 is a block diagram illustrating an exemplary process for determining a team according to some embodiments of the present disclosure;

FIG. 6 is a block diagram illustrating an exemplary team determination module according to some embodiments of the present disclosure;

FIG. 7 is a block diagram illustrating an exemplary process for determining a team according to some embodiments of the present disclosure;

FIG. 8 is a flowchart of an exemplary process for training an acceptance probability model according to some embodiments of the present disclosure;

FIG. 9 is a flowchart of another exemplary process for determining a team according to some embodiments of the present disclosure;

FIG. 10 is a flowchart of another exemplary process for determining a team according to some embodiments of the present disclosure;

FIG. 11 is a block diagram illustrating another exemplary team determination module according to some embodiments of the present disclosure;

FIG. 12 is a flowchart of another exemplary process for determining a team according to some embodiments of the present disclosure;

FIG. 13 is a flowchart of another exemplary process for determining a team according to some embodiments of the present disclosure;

FIG. 14 is a block diagram illustrating another exemplary team determination module according to some embodiments of the present disclosure;

FIG. 15 is a flowchart of another exemplary process for determining a team according to some embodiments of the present disclosure;

FIGS. 16A through 16C are flowcharts of another exemplary process for determining a team according to some embodiments of the present disclosure;

FIG. 17 is an exemplary first interface of a user interface of a device of a user according to some embodiments of the present disclosure;

FIG. 18 is an exemplary second interface of a user interface of a device of a user according to some embodiments of the present disclosure;

FIG. 19 is an exemplary third interface of a user interface of a device of a user according to some embodiments of the present disclosure; and

FIG. 20 is an exemplary personal information setting interface of a user interface of a device of a user according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It will be understood that the term “system,” “module,” and/or “block” used herein are one method to distinguish different components, elements, parts, section or assembly of different level in ascending order. However, the terms may be displaced by another expression if they achieve the same purpose.

The term “module,” or “block,” as used herein, refers to logic embodied in hardware or firmware, or to a collection of software instructions. A module or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an Electrically Programmable Read-Only-Memory (EPROM). It will be further appreciated that hardware modules/units/blocks may be included in connected logic components, such as gates and flip-flops, and/or can be included in programmable units, such as programmable gate arrays or processors. The modules/units/blocks or computing device functionality described herein may be implemented as software modules/units/blocks but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may apply to a system, an engine, or a portion thereof.

It will be understood that when a module or block is referred to as being “connected to,” or “coupled to,” another module, or block, it may be directly connected or coupled to, or communicate with the other module, or block, or an intervening unit, engine, module, or block may be present, unless the context clearly indicates otherwise. As used herein, the term “and/or” includes any and all combinations of at least one of the associated listed items.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, the system or method of the present disclosure may be applied to any other kind of online to offline service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The system or method of the present disclosure may be applied to taxi hailing, chauffeur services, delivery service, carpool, bus service, take-out service, driver hiring, vehicle hiring, bicycle sharing service, train service, subway service, shuttle services, location service, or the like. As another example, the system or method of the present disclosure may be applied to shopping service, learning service, fitness service, financial service, social service, or the like. The application scenarios of the system or method of the present disclosure may include a web page, a plug-in of a browser, a client terminal, a custom system, an internal analysis system, an artificial intelligence robot, or the like, or any combination thereof.

The object of the online to offline service may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistant (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

The term “user” in the present disclosure may refer to an individual, an entity, or a tool that may request a service, order a service, provide a service, or facilitate the providing of the service. In the present disclosure, terms “user” and “user terminal” may be used interchangeably. The term “service provider terminal,” “provider terminal,” and “driver terminal” in the present disclosure are used interchangeably to refer to a mobile terminal that is used by a service provider to provide a service or facilitate the providing of the service. The term “service requester terminal,” “requester terminal,” and “passenger terminal” in the present disclosure are used interchangeably to refer to a mobile terminal that is used by a service requester to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. At least one of the above positioning systems may be used interchangeably in the present disclosure.

An aspect of the present of the present disclosure relates to systems and methods for organizing participants (e.g., drivers) of the online to offline service platform to form one or more teams. Each of the teams may include a team leader and at least one team member. The systems may receive information relating to the plurality of drivers. The systems may determine teams based on the information relating to the plurality of drivers. By forming the teams, drivers can be encouraged to complete more orders through mutual encouragement among drivers and competition with other drivers.

In the present disclosure, the systems may automatically organize participants of the online to offline service system who are online, or the systems may obtain requests from a plurality of participants who wish to be grouped in a team with other participants to work together. The systems may form one or more teams for the participants dynamically and/or in real time based on the online participants or the participants who register to participate in team formation in real time.

The systems may also allow use of information of the plurality of multiple dimensions to determine suitability of organizing the participants. Information of multiple dimensions may include information from, e.g., different times (e.g., historical information, real time information), different sources (e.g., information stored in the storage device of the systems, information input by the participants, etc.) to improve reliability or accuracy of team formation.

Further, the historical information may include historical order information and historical team determination information. The systems may determine driving behavior characteristic for each of the drivers and calculate the similarity of the driving behavior characteristics between the drivers. The systems may determine preference of the participants based on the historical determination information. The systems may organize the participants with similar driving behavior characteristics into a same team and/or take the preference of the participants into consideration to form the teams, which may also improve the success rate and/or reliability of team formation.

Moreover, in some embodiments of the present disclosure, the systems may employ at least one of techniques including embedding authentication information in the request to the service system and/or in the information to a requester terminal, encrypting data for transmission, decrypting received data if the embedded authentication information is verified, or the like, or a combination thereof. This may allow secured communication and/or accurate transmission of specific data to specific devices and/or participants (e.g., team leaders, team members, etc.).

In addition, a user interface for requesting the team formation is provided in the present disclosure. The user interface may include a first interface for receiving a registration instruction (including a leader registration instruction or a member registration instruction), a second interface for displaying information relating to candidate team members matched for a team leader, a third interface for displaying information relating to the team members who agrees to join a team of a team leader or displaying notification, a fourth interface for displaying invitations for inviting a team leader, a fifth interface for displaying activity information, or a personal information setting interface for receiving the personal information input the participants (team leaders or team members). The specific information may be presented in a specific way on the interface of the devices of the participants.

One of the problems solved by the systems and methods of the present disclosure is the big data problem and its real time application faced by an online to offline service system including, for example, an ineffective use of data for processing participants and determining one or more teams for the participants. Further problems solved by the systems and methods of the present disclosure include secured communication in real time between a large number of user devices (e.g., devices of team leaders, device of team members) and/or accurate transmission of specific data to specific user devices and/or specific participants. These problems raise in the online to offline service system appeared in the post-Internet era, and the present disclosure provides solutions to these problems in a technical manner.

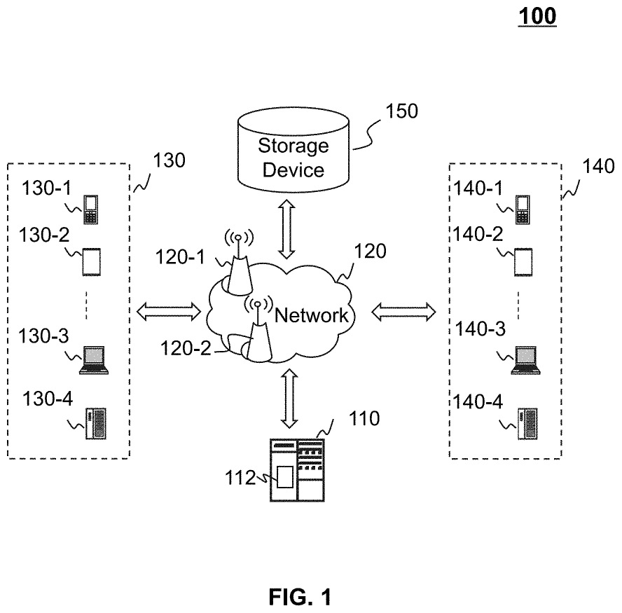

FIG. 1 is a block diagram of an exemplary online to offline service system 100 (briefly referred to herein as system 100) according to some embodiments. For example, the online to offline service system 100 may be an online to offline service system for transportation services (e.g., taxi hailing, chauffeur services, delivery services, carpool, bus services, take-out services, driver hiring, vehicle hiring, train services, subway services, shuttle services), shopping services, fitness services, learning services, financial services, or the like.

The online to offline service system 100 may include a server 110, a network 120, one or more user terminals (e.g., one or more passenger terminals 130, driver terminals 140), and a storage device 150.

The server 110 may include a processing device 112. It should be noted that the online to offline service system 100 shown in FIG. 1 is merely an example, and not intended to be limiting. In some embodiments, the online to offline service system 100 may obtain actual-trip information of an actual ride-sharing trip relating to a trip request initiated by a trip requestor. In some embodiments, the online to offline service system 100 may also determine estimated trip-information of an estimated trip, wherein the estimated trip is not a ride-sharing trip. In some embodiments, the online to offline service system 100 may determine prompt information based on the actual-trip information and the estimated-trip information.

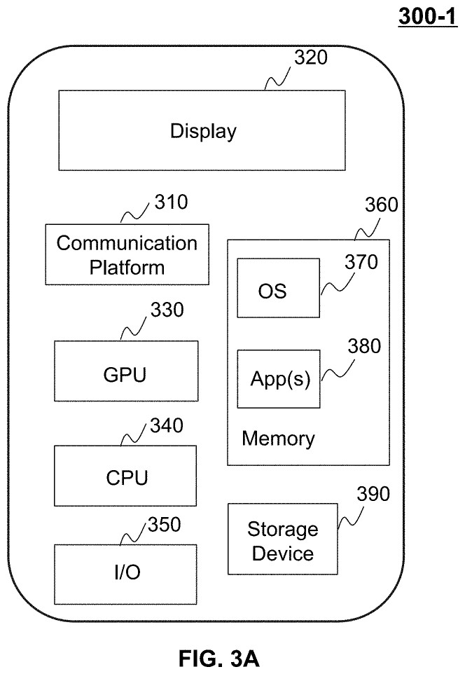

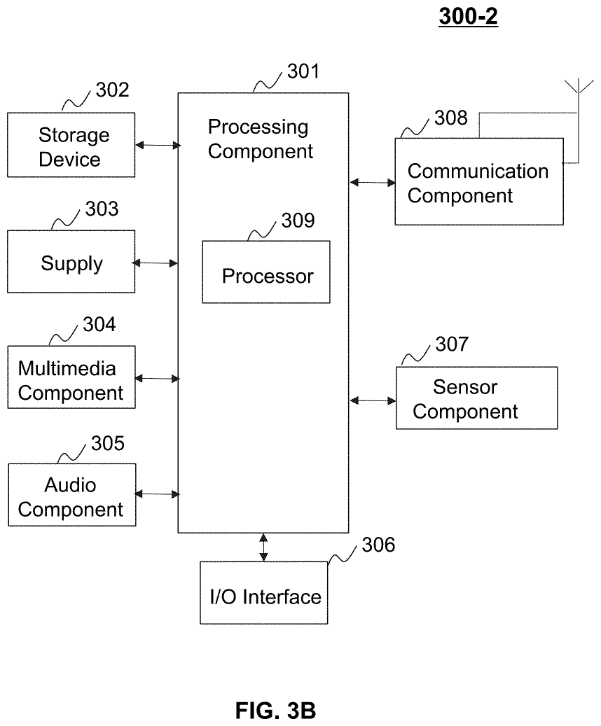

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the one or more user terminals (e.g., the one or more passenger terminals 130, driver terminals 140), and/or the storage device 150 via the network 120. As another example, the server 110 may be directly connected to the one or more user terminals (e.g., the one or more passenger terminals 130, driver terminals 140), and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 300 having one or more components illustrated in FIG. 3 in the present disclosure.

In some embodiments, the server 110 may include a processing device 112. In some embodiments, the processing device 112 may include one or more processing engines (e.g., signal-core processing engine(s) or multi-core processor(s)). Merely by way of example, the processing device 112 may include a central processing unit (CPU), an application-specific integrated circuit (ASIC), an application-specific instruction-set processor(ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the online to offline service system 100 (e.g., the server 110, the one or more passenger terminals 130 the one or more driver terminal 140, or the storage device 150) may send information and/data to other component(s) in the online to offline service system 100 via the network 120. For example, the server 110 may obtain/acquire one or more trip requests from one or more passenger terminals 130 via the network 120. As another example, the server 110 may send prompt signals to the one or more passenger terminals 130 to direct the one or more passenger terminals 130 to display prompt information via the network 120. As a further example, the server 110 may send the one or more trip requests to one driver terminal 140 via the network 120. In some embodiments, the network 120 may be any type of wired or wireless network, or any combination thereof. Merely by way of example, the network 120 may include a cable network, a wireline network, an optical fiber network, a telecommunications network, an intranet, an internet, a local area network (LAN), a wide area network (WAN), a wireless local area network (WLAN), a metropolitan area network (MAN), a wide area network (WAN), a public telephone switched network (PTSN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online to offline service system 100 may be connected to the network 120 to exchange data and/or information.

In some embodiments, the passenger terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the passenger terminal 130 may be a device with positioning technology for locating the position of the service requester and/or the passenger terminal 130.

In some embodiments, the driver terminal 140 may be similar to, or the same device as the passenger terminal 130. The driver terminal 140 may include a mobile device 140-1, a tablet computer 140-2, a laptop computer 140-3, a built-in device in a motor vehicle 140-4, or the like, or any combination thereof. In some embodiments, the driver terminal 140 may be a device with positioning technology for locating the position of the driver and/or the driver terminal 140. In some embodiments, the passenger terminal 130 and/or the driver terminal 140 may communicate with other positioning device to determine the position of the service requester, the passenger terminal 130, the driver, and/or the driver terminal 140. In some embodiments, the passenger terminal 130 and/or the driver terminal 140 may send positioning information to the server 110.

The storage device 150 may store data and/or instructions. For example, the data may be a training model, one or more training samples, historical orders, or the like, or a combination thereof. In some embodiments, the storage device 150 may store data obtained from the one or more user terminals (e.g., the one or more passenger terminals 130, driver terminals 140). In some embodiments, the storage device 150 may store data and/or instructions that the server 110 may execute or use to perform exemplary methods described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the online to offline service system 100 (e.g., the server 110, the one or more user terminals, etc.). One or more components in the online to offline service system 100 may access the data and/or instructions stored in the storage device 150 via the network 120. In some embodiments, the storage device 150 may be directly connected to or communicate with one or more components in the online to offline service system 100 (e.g., the server 110, the one or more user terminals, etc.). In some embodiments, the storage device 150 may be part of the server 110.

In some embodiments, one or more components in the online to offline service system 100 (e.g., the server 110, the one or more user terminals, etc.) may have a permission to access the storage device 150. In some embodiments, one or more components in the online to offline service system 100 may read and/or modify information relating to the service requester, driver, and/or the public when one or more conditions are met. For example, the server 110 may read and/or modify one or more users' information after a service. It should be noted that the online to offline service system 100 is merely an example for illustrating an application of the processing device 112 for determining prompt information for service requestors. The above description of the processing device 112 and the online to offline service system 100 is provided for the purposes of illustration, and is not intended to limit the scope of the present disclosure.

In some embodiments, one or more components of the online to offline service system 100 (e.g., the server 110, the passenger terminal 130, and driver terminal 140, and the storage device 150) may communicate with each other in form of electronic and/or electromagnetic signals, through wired and/or wireless communication. In some embodiments, the online to offline service system 100 may further include at least one information exchange port. The at least one exchange port may be configured to receive information and/or send information relating to the service request (e.g., in the form of electronic signals and/or electromagnetic signals) between any electronic devices in the online to offline service system 100. For example, the at least one information exchange port may receive a request for determining one or more teammates for him/her from the driver terminal 140 through wireless communication between the server 110 and the driver terminal 140. As another example, the at least one information exchange port may send electromagnetic signals including determined teammates to the driver terminal 140 through wireless communication. In some embodiments, the at least one information exchange port may be at least one of an antenna, a network interface, a network port, or the like, or any combination thereof. For example, the at least one information exchange port may be a network port connected to the server 110 to send information thereto and/or receive information transmitted therefrom.

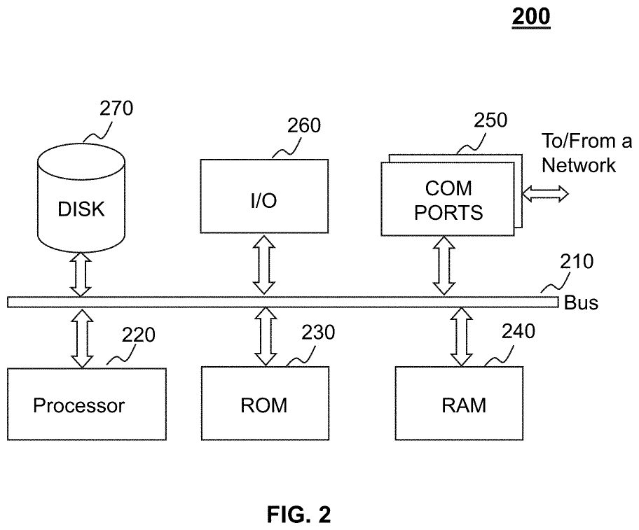

FIG. 2 is a block diagram illustrating exemplary hardware and software components of a computing device 200 on which the server 110, the one or more user terminals (e.g., the one or more passenger terminals 130, driver terminals 140) may be implemented according to some embodiments of the present disclosure. The computing device 200 may be configured to perform one or more functions of the server 110, the passenger terminal 130, and the driver terminal 140 disclosed in this disclosure. For example, the processing device 112 may be implemented on the computing device 200 and configured to perform functions of the processing device 112 disclosed in this disclosure.

The computing device 200 may be a general-purpose computer or a special purpose computer, both may be used to implement an online to offline service system 100 for the present disclosure. The computing device 200 may be used to implement any component of the online to offline service system 100 as described herein. For example, the processing device 112 may be implemented on the computing device 200, via its hardware, software program, firmware, or a combination thereof. Although only one such computer is shown, for convenience, the computer functions relating to the search service as described herein may be implemented in a distributed fashion on a number of similar platforms to distribute the processing load.

The computing device 200, for example, may include COM ports 250 connected to and from a network connected thereto to facilitate data communications. The computing device 200 may also include a processor 220, in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. The processing circuits may also generate electronic signals including the conclusion or the result (e.g., the information relating to a driver) and a triggering code. In some embodiments, the trigger code may be in a format recognizable by an operation system (or an application installed therein) of an electronic device (e.g., the passenger terminal 130) in the system 100. For example, the trigger code may be an instruction, a code, a mark, a symbol, or the like, or any combination thereof, that can activate certain functions and/or operations of a mobile phone or let the mobile phone execute a predetermined program(s). In some embodiments, the trigger code may be configured to rend the operation system (or the application) of the electronic device to generate a presentation of the conclusion or the result (e.g., the result relating to the team determination) on an interface of the electronic device. Then the interface circuits may send out the electronic signals from the processing circuits via the bus 210.

The exemplary computer platform may include the internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 may also include an I/O component 260, supporting input/output between the computer and other components therein. The computing device 200 may also receive programming and data via network communications.

The computing device 200 may also include a hard disk controller communicated with a hard disk, a keypad/keyboard controller communicated with a keypad/keyboard, a serial interface controller communicated with a serial peripheral equipment, a parallel interface controller communicated with a parallel peripheral equipment, a display controller communicated with a display, or the like, or any combination thereof.

Merely for illustration, only one CPU and/or processor is described in the computing device 200. However, it should be noted that the computing device 300 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 300 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

FIG. 3A is a block diagram of an exemplary mobile device 300-1 configured to implement a specific system disclosed in the present disclosure. In some embodiments, a user terminal configured to display and communicate information related to locations may be a mobile device 300-1. The mobile device 300-1 may include but is not limited to a smartphone, a tablet computer, a music player, a portable game console, a GPS receiver, a wearable calculating device (e.g., glasses, watches, etc.), or the like. The mobile device 300-1 may include one or more central processing units (CPUs) 340, one or more graphical processing units (GPUs) 330, a display 320, a memory 360, a communication platform 310, a storage device 390, and an input/output (I/O) 350. In some embodiments, the CPU may include interface circuits and processing circuits. Moreover, the mobile device 300-1 may also be any other suitable component that includes but is not limited to a system bus or a controller (not shown in FIG. 3A). As shown in FIG. 3A, a mobile operating system (OS) 370 (e.g., iOS, android, windows Phone, etc.) and one or more applications 380 may be loaded from the storage device 390 to the memory 360 and implemented by the CPUs 340. The application 380 may include a browser or other mobile applications configured to receive and process information related to a query (e.g., a name of a location) inputted by a user in the mobile device 300-1. The passenger/driver may obtain information related to one or more search results through the system I/O device 350, and provide the information to the server 110 and/or other modules or units of the online to offline service system 100 (e.g., the network 120).

In order to implement various modules, units and their functions described above, a computer hardware platform may be used as hardware platforms of one or more elements. Since these hardware elements, operating systems and program languages are common, it may be assumed that persons skilled in the art may be familiar with these techniques and they may be able to provide information required in the online to offline service according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the Figures.

FIG. 3B is a block diagram illustrating another exemplary user terminal according to some embodiments of the present disclosure. As shown in FIG. 3B, a user terminal may be implemented on a mobile phone, a computer, a tablet device, a personal digital assistant, or the like. The user terminal 300-2 may include a storage device 302, a processor 309, and a computer program. The computer program may be stored in the storage device 302, and may be configured to be executed by the processor 309 to implement the determination of teams for drivers.

In some embodiments, the user terminal 300-2 may also include a processing component 301, a power component 303, a multimedia component 304, an audio component 305, an input/output (I/O) interface 306, a sensor component 307, and a communication component 308.

The processing component 301 may control the overall operation of the user terminal 300-2, such as operations associated with display, telephone calls, data communications, camera operations, and recording operations. The processing component 301 may include one or more processors 309 to execute instructions to complete all or part of the steps of the method described in the present disclosure. In addition, the processing component 301 may include one or more modules to facilitate interaction between the processing component 301 and other components.

The storage device 302 may be configured to store various types of data to support operation at the user terminal 300-2. Examples of such data may include instructions for any applications or methods for operation on the user terminal 300-2, contact data, phone book data, messages, pictures, videos, or the like. The storage device 302 may be implemented by any type of volatile or non-volatile storage device, or a combination thereof, such as Static Random Access Memory (SRAM), Electrically Erasable Programmable Read Only Memory (EEPROM), Erasable Programmable Read Only Memory (EPROM), Programmable Read Only Memory (PROM), Read Only Memory (ROM), Magnetic Memory, Flash Memory, Disk, or Optical Disk.

The power component 303 may provide power to various components of the user terminal 300-2. The power component 303 may include a power management system, one or more power supplies, and/or other components associated with generating, managing, and distributing power for the user terminal 300-2.

The multimedia component 304 may include a screen that may provide an output interface between the user terminal 300-2 and the user. In some embodiments, the screen may include a liquid crystal display (LCD) and a touch panel (TP). If the screen includes a touch panel, the screen may be implemented as a touch screen to receive input signals from the user. The touch panel may include one or more touch sensors to sense touches, swipe, and gestures on the touch panel. The touch sensor may sense not only the boundary of the touch or sliding action, but also the duration and pressure associated with the touch or slide operation. In some embodiments, the multimedia component 304 may include a front camera and/or a rear camera. When the user terminal 300-2 is in an operation mode, such as a shooting mode or a video mode, the front camera and/or the rear camera may receive external multimedia data. Each front and rear camera may be a fixed optical lens system or has a focal length and an optical zoom capability.

The audio component 305 may be configured to output and/or input an audio signal. For example, the audio component 305 may include a microphone (MIC) that may be configured to receive an external audio signal when the user terminal 300-2 is in an operational mode, such as a call mode, a recording mode, or a voice recognition mode. The received audio signal may be further stored in the storage device 302 or transmitted via the communication component 308. In some embodiments, the audio component 305 may also include a speaker for outputting an audio signal.

The I/O interface 306 may provide an interface between the processing component 301 and the peripheral interface module, which may be a keyboard, a click wheel, a button, or the like. These buttons may include, but are not limited to, a home button, a volume button, a start button, or a lock button.

The sensor component 307 may include one or more sensors for providing a status evaluation of various aspects for the user terminal 300-2. For example, the sensor component 307 may detect the open/closed state of the user terminal 300-2, the relative positioning of the components, such as the component which is a display and keypad of the user terminal 300-2 and the sensor component 307 may also detect the user terminal 300-2 or a change in position of a component of the user terminal 300-2, the presence or absence of contact between the user contact with the user terminal 300-2, the user terminal 300-2 orientation or acceleration/deceleration and temperature change of the user terminal 300-2. The sensor component 307 may include a proximity sensor configured to detect the presence of nearby objects without any physical contact. The sensor component 307 may also include a light sensor, such as a CMOS or CCD image sensor, for use in imaging applications. In some embodiments, the sensor component 307 may further include an acceleration sensor, a gyro sensor, a magnetic sensor, a pressure sensor, or a temperature sensor.

The communication component 308 may be configured to facilitate wired or wireless communication between the user terminal 300-2 and other devices. The user terminal 300-2 can access a wireless network based on a communication standard such as Wi-Fi, 2G or 3G, or a combination thereof. In some embodiments, the communication component 308 may receive broadcast signals or broadcast related information from an external broadcast management system via a broadcast channel. In some embodiments, the communication component 308 may also include a near field communication (NFC) module to facilitate short range communication. For example, the NFC module can be implemented based on a radio frequency identification (RFID) technology, an infrared data association (IrDA) technology, an ultra-wideband (UWB) technology, a Bluetooth (BT) technology, or the like, or a combination thereof.

In some embodiments, the user terminal 300-2 may include one or more application specific integrated circuits (ASICs), digital signal processors (DSPs), digital signal processing devices (DSPDs), programmable logic devices (PLD), Field Programmable Gate Arrays (FPGA), controllers, microcontrollers, microprocessors, or other electronic component.

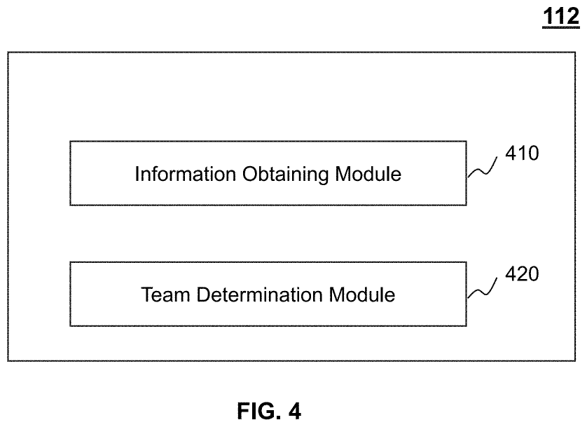

FIG. 4 is a block diagram illustrating an exemplary processing device 112 according to some embodiments of the present disclosure. In some embodiments, the processing device 112 may be in communication with a computer-readable storage (e.g., the storage device 150) and may execute instructions stored in the computer-readable storage medium. The processing device 112 may include an information obtaining module 410 and a team determination module 420. The modules may be hardware circuits of all or part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application/set of instructions.

The information obtaining module 410 may be used to obtain information and/or data related to the team determination (or referred to as team formation) process. In some embodiments, the information obtaining module 410 may obtain information of a plurality of participants to be grouped. The plurality of participants may include a plurality of team leaders and a plurality of team members. In some embodiments, the information of team leaders to be grouped and the information of team members to be grouped may include, but not limited to, natural attribute information, social attribute information, or habitual attribute information. The natural attribute information may include age, hometown, gender, height, weight, or the like, or any combination thereof. The social attribute information may include name, occupation, industry, family role, family information, social role, or the like, or any combination thereof. The habitual attribute information may include hobbies, specialties, habits, or the like, or any combination thereof. In some embodiments, when the team leaders and the team members are drivers, the information of the team leaders and team members may also include the driver's driving age, service level (service points), and/or vehicle type, color, brand, license plate number, capacity (such as 4 or 7 seats, etc.), additional attributes (such as panoramic sunroof), driving mileage, age, or the like, or any combination thereof.

In some embodiments, the information obtaining module 410 may obtain historical team determination data. The historical team determination data may include the information and/or data that was generated in the team recommendation processes and/or results.

In some embodiments, the information obtaining module 410 may also obtain evaluation information of the plurality of participants (include team leaders and team members) to be grouped. In some embodiments, the evaluation information of the team participants to be grouped may include evaluation information of the platform participants to be grouped, evaluation information obtained by the team participants to be grouped, or the like, or any combination thereof. In some embodiments, the team participants to be grouped can be drivers (such as online car-hailing drivers). In example embodiments in which the team participants to be grouped are drivers, the evaluation information of the team participants to be grouped may include at least one of the evaluation information of the drivers on the online car-hailing platform, the passenger's evaluation information on the drivers, and the drivers' comprehensive rating information, or the like, or any combination thereof. In some embodiments, the information obtaining module 410 may obtain the historical order information relating to the plurality of participants. In some embodiments, the historical order information may include information of driver, order accepting time, or order accepting location. The historical order information may also include passenger information, starting location, destination location, starting time to the starting location, time to arrive at the destination location, payment information, or the like, or a combination thereof.

The team determination module 420 may be determine one or more teams by automatically allocating the plurality of team members to the plurality of team leaders based on the information relating to the plurality of team participants. Each of the one or more teams may include a team leader and at least one team member. In some embodiments, the team determination module 420 may first determine an acceptance probability between each of the plurality of team leaders and each of the plurality of team members based on the information relating to the plurality of team participants. The team determination module 420 may then determine a team recommendation scheme based on the acceptance probabilities using an optimization recommendation algorithm and determine the one or more teams based on the team recommendation scheme. In some embodiments, the team determination module 420 may first determine a matching value between each of the plurality of team leaders and each of the plurality of team members based on the information relating to the plurality of team participants. The team determination module 420 may then determine the one or more teams based on the matching values. In some embodiments, the team determination module 420 may assign each of the plurality of team participants to a group based on the evaluation information relating to the each of the plurality of team participants and determine the one or more teams based on the group assignment relating to each of the plurality of team participants. In some embodiments, the team determination module 420 may determine a driving behavior characteristic for each of the plurality of team participants based on the historical order information relating to each of the plurality of team participants, divide the plurality of team participants into one or more driver groups based on the driving behavior characteristic of each of the plurality of team participants, and determine at least one team for each of the one or more driver groups.

It should be noted that the above description of the processing device 112 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, any module mentioned above may be divided into two or more units. In some embodiments, the processing device 112 may further include one or more additional modules. For example, the processing device 112 may further include an encrypt module configured to encrypt information and/or a decrypt module configured to decrypt information.

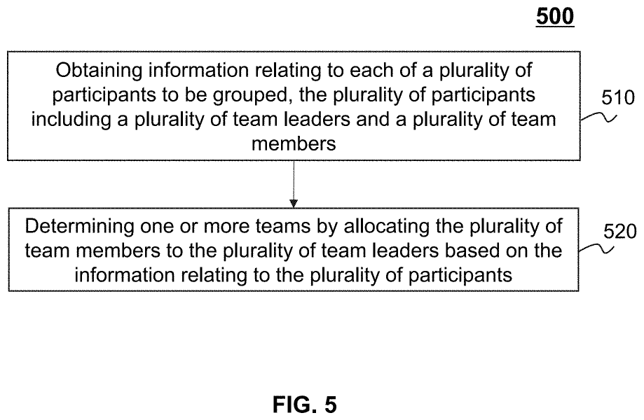

FIG. 5 is a block diagram illustrating an exemplary process for determining a team according to some embodiments of the present disclosure. In some embodiments, the process 500 may be executed by the service system 100. For example, the process 500 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 500 in a service platform (e.g., the online to offline service system 100). The platform may be an Internet-based platform that connects service providers and requesters through the Internet.

In some embodiments, the processing device 112 may receive a request for determination of a team from a driver terminal 140 via a user interface of the driver terminal 140. In some embodiments, the request may be encrypted by the driver terminals 140. The processing device 112 may decrypt the encrypted request after receiving the encrypted request. Merely by way of example, the driver terminal may encrypt the request using its private key and/or digitally sign the request. The processing device 112 may decrypt the request using a public key of the driver terminal. In some embodiments, the encrypted request may include authentication information related to the driver terminal and/or the driver, such as an identification of the driver, a password inputted by the driver, and/or a digital signature of the driver terminal. The processing device 112 may verify the authentication information of the requester terminal and/or the requester before the decrypting.

In 510, the processing device 112 (e.g., the information obtaining module 410) may obtain information relating to each of a plurality of team participants (e.g., the service providers) to be grouped. The plurality of team participants may include a plurality of team leaders and a plurality of team members.

In some embodiments, the information relating to each the plurality of team participants may also be encrypted by the driver terminals 140 or be encrypted by the storage device of the online to offline service system 100 (e.g., the storage device 150, the ROM 230, the RAM 240, etc.) when the information is stored in the storage device of the online to offline service system 100. The processing device 112 may decrypt the encrypted information after receiving the encrypted information. Merely by way of example, the driver terminal may encrypt the information using its private key and/or digitally sign the request. The processing device 112 may decrypt the information using a public key of the driver terminal. In some embodiments, the encrypted information may include authentication information related to the driver, such as an identification of the driver, a password inputted by the driver, and/or a digital signature of the driver. The processing device 112 may verify the authentication information of the driver terminal and/or the driver before the decrypting.

In some embodiments, the information relating to each of the plurality of team participants may include natural attribute information, social attribute information, habitual attribute information, or the like, or any combination thereof. The natural attribute information may include age, hometown, gender, height, weight, and the like, or any combination thereof. The social attribute information may include name, occupation, industry, family role, family information, social role, or the like, or any combination thereof. The habitual attribute information may include hobbies, specialties, habits, or the like, or any combination thereof. In some embodiments, when team leaders and team members to be grouped are drivers, the information of team leaders and team members to be grouped may also include the driver's driving age, service level (service points), and/or vehicle type, color, brand, license plate number, capacity (such as 4 or 7 seats, etc.), additional attributes (such as panoramic sunroof), driving mileage, age, or the like, or any combination thereof.

In some embodiments, the information relating to each of the plurality of team participants may include historical team determination data relating to the each of the plurality of team participants. The historical team determination data may include information or data generated during the process of determining one or more teams or information or data included in the result of team determination or formation.

In some embodiments, the information relating to each of the plurality of team participants may include evaluation information relating to each of the plurality of team participants. The evaluation information of some embodiments, team participants to be grouped may include evaluation information of the platform by the team participants to be grouped, evaluation information obtained by the team participants to be grouped, or the like, or any combination thereof. In some embodiments, the team participants to be grouped can be drivers (such as online car-hailing drivers). In a specific embodiment in which the team participants to be grouped are driver, the evaluation information of the team participants to be grouped may include at least one of the evaluation information of the drivers on the online car-hailing platform, the evaluation information of one or more passengers on the drivers, or the driver's integrated rating, or the like, or any combination thereof.

In some embodiments, the information relating to each of the plurality of team participants may include historical order information relating to each of the plurality of team participants. The historical order information includes: information of drivers, order accepting time, or order accepting location. The historical order information may also include passenger information, starting location, destination location, starting time to the starting location, time to arrive at the destination location, payment information, or the like, or any combination thereof.

In 520, the processing device 112 (e.g., the team determination module 420) may determine one or more teams by automatically allocating the plurality of team members to the plurality of team leaders based on the information relating to the plurality of team participants. Each of the one or more teams may include a team leader and at least one team member.

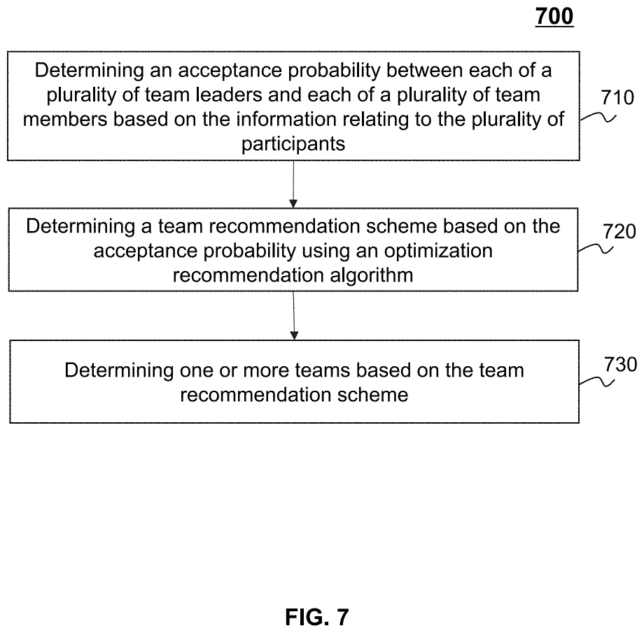

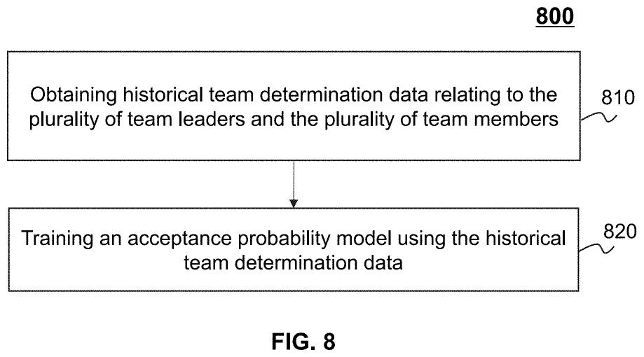

In some embodiments, the team determination module 420 may first determine an acceptance probability between each of the plurality of team leaders and each of the plurality of team members based on the information relating to the plurality of team participants. The team determination module 420 may then determine a team recommendation scheme based on the acceptance probabilities using an optimization recommendation algorithm and determine the one or more teams based on the team recommendation scheme. More descriptions regarding the process of determining the one or more teams based on the acceptance probabilities may be found elsewhere in the present disclosure. See, e.g., FIGS. 7 and 8 and the relevant descriptions thereof.

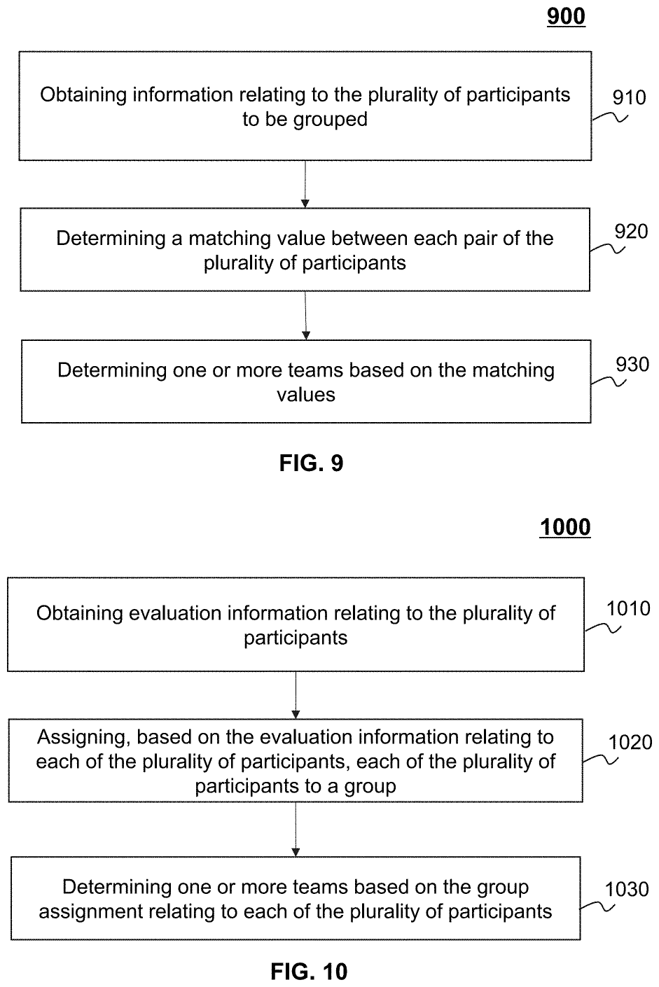

In some embodiments, the team determination module 420 may first determine a matching value between each of the plurality of team leaders and each of the plurality of team members based on the information relating to the plurality of team participants. The team determination module 420 may then determine the one or more teams based on the matching values. More descriptions regarding the process of determining the one or more teams based on the matching values may be found elsewhere in the present disclosure. See, e.g., FIG. 9 and the relevant descriptions thereof.

In some embodiments, the team determination module 420 may assign each of the plurality of team participants to a group based on the evaluation information relating to the each of the plurality of team participants and determine the one or more teams based on the group assignment relating to each of the plurality of team members. In some embodiments, the evaluation information relating to a participant of the plurality of team participants may include evaluation information of the participant on the online to offline service platform. The groups may include a recommender group, a passive person group, and a detractor group. In some embodiments, the evaluation information relating to a participant of the plurality of team participants may include evaluation information that a service requestor provides regarding the participant. The groups may include a high-quality service group, a general-quality service group, and a poor-quality service group. More descriptions regarding the process of determining the one or more teams based on the evaluation information may be found elsewhere in the present disclosure. See, e.g., FIG. 10 and the relevant descriptions thereof.

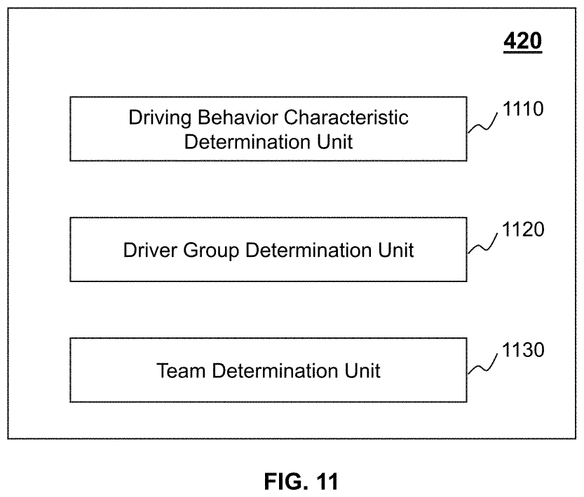

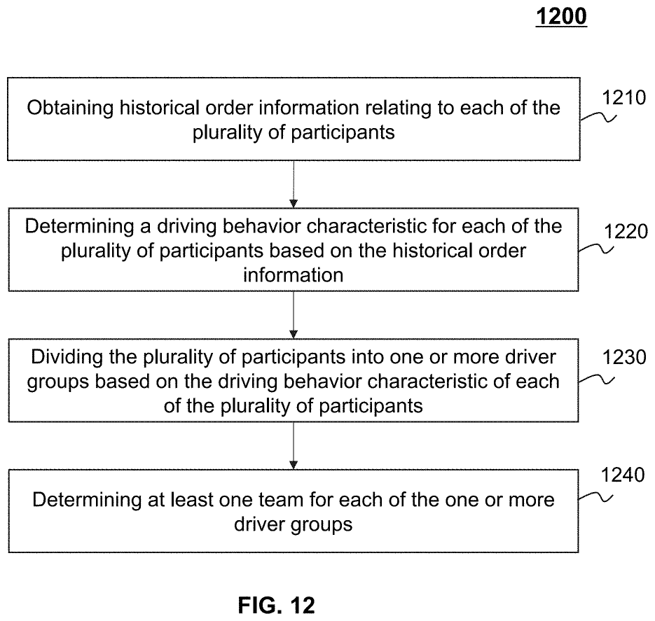

In some embodiments, the team determination module 420 may determine a driving behavior characteristic for each of the plurality of team participants based on the historical order information relating to each of the plurality of team participants, divide the plurality of team members into one or more driver groups based on the driving behavior characteristic of each of the plurality of team participants, and determine at least one team for each of the one or more driver groups. More descriptions regarding the process of determining the one or more teams based on the historical order information may be found elsewhere in the present disclosure. See, e.g., FIGS. 11 and 12 and the relevant descriptions thereof.

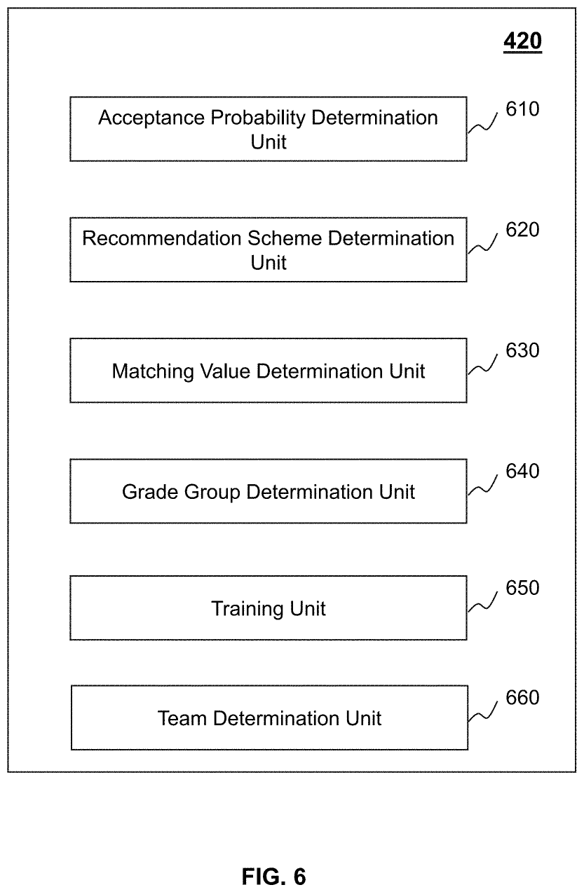

FIG. 6 is a block diagram illustrating an exemplary team determination module according to some embodiments of the present disclosure. As shown in FIG. 6, the team determination module 420 may include an acceptance probability determination unit 610, a recommendation scheme determination unit 620, a matching value determination unit 630, a grade group determination unit 640, a training unit 650, and a team determination unit 660. The modules may be hardware circuits of all or part of team determination module 420. The modules may also be implemented as an application or set of instructions read and executed by the team determination module 420. Further, the modules may be any combination of the hardware circuits and the application/instructions. For example, the modules may be the part of the processing device 112 when the team determination module 420 is executing the application/set of instructions.

The acceptance probability determination unit 610 may be configured to determine the acceptance probability between each of a plurality of team leaders to be grouped and each of a plurality of team members to be grouped. In some embodiments, the acceptance probability determination unit 610 may determine an acceptance probability between the plurality of team leaders to be grouped and the plurality of team members to be grouped based on the information of the plurality of team leaders to be grouped and the information of the plurality of team members to be grouped. In some embodiments, the acceptance probability determination unit 610 may determine an acceptance probability between each team leader to be grouped and each team member to be grouped according to an acceptance probability model. In some embodiments, the acceptable probability determination unit 610 may determine an acceptance probability between a portion of the team leaders to be grouped and a portion of the team members to be grouped.

The recommendation scheme determination unit 620 may be configured to determine a team recommendation scheme. For example, the recommendation scheme determination unit 620 may determine the team recommendation scheme according to the optimization recommendation algorithm based on the acceptance probability between multiple team leaders to be grouped and multiple team members to be grouped. In some embodiments, the recommendation scheme determination unit 620 may be used to determine the expected success probability for a plurality of candidate team recommendation schemes. The recommendation scheme determination unit 620 may determine the team recommendation that has the highest expected success rate of team formation as the team recommendation scheme. The recommendation scheme determination unit 620 may establish a team determination success rate expectation model. The recommendation scheme determination unit 620 may determine a team recommendation scheme based on the team determination success rate expectation model according to the combination optimization algorithm. The recommendation scheme determination unit 620 may determine the sum of the probabilities of successful team formation in different states of intention to accept a team formation recommendation (referred to as acceptance intention). The recommendation scheme determination unit 620 may determine a team recommendation that maximizes the sum of the probabilities of successful team formation.

The matching value determination unit 630 may be configured to determine the matching value between the team participants to be grouped. In some embodiments, the matching value determination unit 630 may determine a matching value between the team participants to be grouped based on the information of the team participants to be grouped. For example, the matching value determination unit 630 may determine the matching value between all team participants to be grouped. In some embodiments, the matching value determination unit 630 may determine the matching value between each team leader to be grouped and each team member to be grouped. In some embodiments, the matching value determination unit 630 may compare some or all the attribute information (e.g. natural attribute information, social attribute information, habitual attribute information) of the team participants to be grouped, and determine the similarity of part or all the attribute information between the team participants to be grouped according to the comparison result.

The grade group determination unit 640 may be configured to determine one or more grade groups (also briefly referred to as groups) for the team participants to be grouped. In some embodiments, the number or the count of the grade groups may be at least two. For example, the grade group determination unit 640 can determine the grade groups for the team participants to be grouped according to the evaluation information of the team participants to be grouped. In some embodiments, the grade group determination unit 640 may determine the grade groups for the team participants to be grouped using a classification model based on the evaluation information of the team participants to be grouped. In some embodiments, the grade group determination unit 640 may use a decision tree to determine the grade groups of the team participants to be grouped. For example, the grade group determination unit 640 may take the evaluation information of the team participants to be grouped as input, and determine the grade groups for the team participants to be grouped by constructing a decision tree model. In some embodiments, the grade group determination unit 640 may determine a driver belonging to a recommender group, a passive person group, or a detractor group based on the evaluation information of the driver on the online car-hailing platform. In some embodiments, the grade group determination unit 640 may be configured to determine a driver belonging to a high-quality service group, a general-quality service group, or a poor-quality service group according to the evaluation information of the passengers on the driver.

The training unit 650 may be configured to train to obtain an acceptance probability model. In some embodiments, the training unit 650 may generate an acceptance probability model based on the historical team determination data. In some embodiments, the training unit 650 may generate an acceptance probability model according to a machine learning method based on the historical team determination data. For example, the training unit 650 may be trained to obtain an acceptance probability model according to a logistic regression (LR) algorithm.

The team determination unit 660 may be configured to determine one or more teams for the team participants to be grouped. For example, the team determination unit 660 may determine one or more teams for the team participants to be grouped based on the matching value between the team participants to be grouped. In some embodiments, the team determination unit 660 may determine the teams for the team participants to be grouped according to the grade group of the team member to be grouped. In some embodiments, the team determination unit 660 may determine the teams for different grade groups of team participants to be grouped. In some embodiments, the team determination unit 660 may determine the teams for team participants of the same grade group to be grouped.

It should be understood that the modules shown in FIG. 6 may be implemented in various ways. For example, in some embodiments, system and its modules may be implemented by hardware, software or a combination of software and hardware. Herein, the hardware portion may be implemented using dedicated logic; the software portion can be stored in memory and executed by a suitable instruction execution system, such as a microprocessor or dedicated design hardware. Those skilled in the art will appreciate that the methods and systems described above may be implemented using computer-executable instructions and/or embodied in processor control code, such as a carrier medium such as a magnetic disk, CD or DVD-ROM, such as read-only memory (firmware) Such code is provided on a programmable memory or on a data carrier such as an optical or electronic signal carrier. The system of the present application and its modules may be implemented not only with hardware such as very large-scale integrated circuits or gate arrays, semiconductors such as logic chips, transistors, etc., or programmable hardware devices such as field programmable gate arrays, programmable logic devices, and the like. It may also be implemented by, for example, software executed by various types of processors, or by a combination of the above-described hardware circuits and software (for example, firmware).

It should be noted that the above description of the team determination module 420 and its modules is merely for convenience of description, and the present application is not limited to the scope of the embodiments. It will be understood that, after understanding the principles of the system, it is possible for those skilled in the art to arbitrarily combine the various modules or connect the other subsystems without departing from the principle. For example, in some embodiments, the information obtaining module 410, the acceptance probability determination unit 610, the recommendation scheme determination unit 620, the matching value determination unit 630, the grade group determination unit 640, the training unit 650, and the team determination unit 660 may be I different modules in a system, or may be a module to implement the functions of two or more modules mentioned above. For example, the acceptance probability determination unit 610, the recommendation scheme determination unit 620, the matching value determination unit 630, and the grade group determination unit 640 may be four modules, or may be a module (such as a determination module) to simultaneously determine the acceptance probability, determine the recommended scheme, determine the matching value, and determine the level group and other functions. As another example, each module may share one storage module, and each module may also have a separate storage module. Variations are within the scope of the present application. In some embodiments, the team determination module 420 may further include one or more additional units or one or more above-mentioned units may be omitted. For example, the team determination module 420 may further include an encrypt module configured to encrypt information and/or a decrypt module configured to decrypt information.

FIG. 7 is a block diagram illustrating an exemplary process for determining a team according to some embodiments of the present disclosure. In some embodiments, the process 700 may be executed by the service system 100. For example, the process 700 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 700 in a service platform (e.g., the online to offline service system 100). The platform may be an Internet-based platform that connects service providers and requesters through the Internet.

In 710, the processing device 112 may determine an acceptance probability between each of the plurality of team leaders to be grouped and each of the plurality of team members to be grouped based on the information of the plurality of participants (including the information of the plurality of team leaders to be grouped and information of the plurality of team members). In some embodiments, step 710 may be performed by the acceptance probability determination unit 610.

In some embodiments, the online to offline service system 100 (such as the information obtaining module 410) may obtain information the plurality of team leaders to be grouped and information of the plurality of team members. In some embodiments, the team leaders to be grouped and team members to be grouped may be drivers. For example, the team leaders to be grouped and team members to be grouped may be drivers for online car-hailing services. In some embodiments, drivers may be free to choose whether to apply for determination of a team. For example, drivers can select an independent order or a team order through the driver terminal 140 (e.g. online car-hailing service terminal). In some embodiments, when the driver selects a team order, the driver may choose to sign up as team leader or team member. In general, the team leader plays the leading role of the entire team during the team formation process or after the team is formed. For example, the team leader may choose which driver can be a team member of a team. As another example, the team leader may manage the team after the team is formed (e.g., task assignment, member management, etc.). In some embodiments, team members may choose to join a team leader's team. For example, the system may recommend multiple team leaders (such as 2, 3, 5, etc.) to the team member. The team member may pick one from the multiple team leaders and join his/her team. It should be noted that the online car-hailing drivers are only one specific application embodiment of the online to offline service system 100 disclosed by the present disclosure. The range of applications for this online to offline service system is not limited to drivers or online car-hailing drivers. For example, the online to offline service system may also be applied to any reasonable scenario or field such as takeaway, express delivery, and gaming.

In some embodiments, the system 100 may require a requestor requesting forming a team (registering as a team leader and/or team member) after satisfying certain conditions. In some embodiments, the condition may include, but is not limited to, the service time of the drivers in the online car-hailing platform exceeds a certain threshold (e.g., half year, 1 year, 2 years, 3 years, etc.), the number (or count) of completed service orders exceeds a certain threshold (e.g. 500 orders, 1000 orders, etc.), service evaluation (e.g., passengers' ratings for drivers) exceed s certain threshold (e.g., scores greater than 4.5/5 points), or the like, or any combination thereof. In some embodiments, the criteria for registering as a team leader may be higher than the criteria for registering as a team member. For example, the system may require a driver to register as the team leader when the number (or count) of times that he/she has been a team member for the team formation exceeds a certain threshold (e.g., 10, 20, etc.). In some embodiments, the system 100 (e.g., processing device 112) may adjust the number (or count) of team leaders and the number (or count) of team members. For example, when there are too many people who attempt to register, system 100 may designate some of team members as team leaders. In some embodiments, drivers may register to participate in team formation without specifying to be a team leader or a team member. In some embodiments, the system 100 may specify (or randomly assign) a portion of the registered drivers as team leaders.

In some embodiments, when a driver registers to determine a team (register to be a team leader or a team member), the system 100 may obtain the information of the driver. For example, the processing device 112 may obtain the drivers' information from the driver terminal 140 over the network 120. As another example, after the driver terminal 140 sends a request for the team formation, the processing device 112 may obtain the corresponding information of the driver from the storage device 150.

In some embodiments, the information of team leaders to be grouped and the information of team members to be grouped may include, but is not limited to, natural attribute information, social attribute information, or habitual attribute information. The natural attribute information may include age, hometown, gender, height, weight, or the like, or any combination thereof. The social attribute information may include name, occupation, industry, family role, family information, social role, or the like, or any combination thereof. The habitual attribute information may include hobbies, specialties, habits, or the like, or any combination thereof. In some embodiments, when team leaders to be grouped and team members to be grouped are drivers, the information of team leaders to be grouped and the information of team members may also include the driving age of the drivers, the service level (service points), and/or vehicle type, color, brand, license plate number, capacity (e.g. 4 or 7 seats, etc.), additional attributes (such as panoramic sunroof), driving mileage, age, or the like, or any combination thereof.

In some embodiments, the processing device 112 may determine an acceptance probability between a plurality of team leaders to be grouped and a plurality of team members to be grouped according to an acceptance probability model. In some embodiments, the acceptance probability model may be obtained based on the training of the historical team determination data. In some embodiments, the acceptance model may be obtained based on a machine learning algorithm (e.g. a logistic regression algorithm). In some embodiments, the system 100 may determine the acceptance probability between each team leader to be grouped and each team member to be grouped.

In 720, the processing device 112 may determine a team recommendation scheme based on the acceptance probability between the plurality of team leaders to be grouped and the plurality of team members to be grouped using an optimization recommendation algorithm. In some embodiments, the step 720 may be performed by the recommendation scheme determination unit 620.

In some embodiments (such as FIG. 8 and related descriptions), it may be assumed that the acceptance probability matrix between n team leaders to be grouped and m team members to be grouped is expressed as matrix L showing as equation (1):

$${l}_{1} {l}_{2} … {l}_{n} \\ L = \begin{matrix}{m}_{1} \\ {m}_{2} \\ ⋮ \\ {m}_{4}\end{matrix} [ \begin{matrix}{p}_{11} & {p}_{12} & … & {p}_{1 n} \\ {p}_{21} & {p}_{22} & … & {p}_{2 n} \\ ⋮ & ⋮ & ⋱ & ⋮ \\ {p}_{m 1} & {p}_{m 2} & … & {p}_{m n}\end{matrix} ] , \qquad ( 1 )$$

wherein, pᵢⱼ denotes the probability that the team leader to be grouped l receives the team member to be grouped mᵢ, pᵢⱼ ∈[0,1].

In some embodiments, the determining of the team recommendation scheme using the optimization recommendation algorithm may include: determining an expected success rate for team determination with respect to each of a plurality of candidate team recommendation schemes; determining a team recommendation scheme corresponding to the highest success rate as a final team recommendation scheme. In some embodiments, the determining of the team recommendation scheme according to the optimization recommendation algorithm may include: establishing an expectation model for determining a success rate for team determination (also referred to herein as a team determination success rate expectation model); and determining the team recommendation scheme based on the expectation model for determining a success rate for team determination according to a combination optimization algorithm.

Assume that the recommendation relationship between the team leaders and team members can be represented by the following recommendation matrix R showing as equation (2):

$${l}_{1} {l}_{2} … {l}_{n} \\ R = \begin{matrix}{m}_{1} \\ {m}_{2} \\ ⋮ \\ {m}_{4}\end{matrix} [ \begin{matrix}{b}_{11} & {b}_{12} & … & {b}_{1 n} \\ {b}_{21} & {b}_{22} & … & {b}_{2 n} \\ ⋮ & ⋮ & ⋱ & ⋮ \\ {b}_{m 1} & {b}_{m 2} & … & {b}_{m n}\end{matrix} ] , \qquad ( 2 )$$

wherein, bᵢⱼ indicates whether the team member mᵢ is recommended to the team leader lⱼ. Wherein, the team leader lⱼ can be assigned to Lⱼ team members at most. Team member mᵢ can be assigned to Mᵢ team leaders at most. That is:

$$\{ \begin{matrix}{b}_{i j} ∈ \{ 0 , 1 \} & \\ {\sum }_{i = 1}^{m} [ {b}_{i j} = 1 ] \leq {L}_{j} & \\ {\sum }_{j = 1}^{n} [ {b}_{i j} = 1 ] \leq {M}_{i} & \end{matrix} . \qquad ( 3 )$$

According to the acceptance probability matrix L and the recommendation matrix R, the expected success rate may be expressed as E_{(L,R)}. Determining the candidate team recommendation scheme with the biggest expected success rate as the final team recommendation scheme may be described as: Determine the recommendation matrix R when the value of E_{(L,R)} is the largest. That is:

$$\hat{R} = {arg min}_{R} - {E}_{( L , R )} , \qquad ( 4 )$$

wherein, \hat{R} indicates the team recommendation scheme, and argmin/R−E_{(L,R)} indicates R when the value of E_{(L,R)} is the largest.

In some embodiments, the success rate expectation model may be established in various ways. The following describes two embodiments for determining the success rate expectation model embodiments (Example 1, Example 2). It should be noted that the expectation model for determining a success rate for team determination may also take many other forms, and the present disclosure does not limit in this application.

### Example 1

In this example, n team leaders to be grouped willing to accept m team members to be grouped can be expressed as an acceptance intention matrix Q showing as equation (5):

$${l}_{1} {l}_{2} … {l}_{n} \\ Q = \begin{matrix}{m}_{1} \\ {m}_{2} \\ ⋮ \\ {m}_{4}\end{matrix} [ \begin{matrix}{c}_{11} & {c}_{12} & … & {c}_{1 n} \\ {c}_{21} & {c}_{22} & … & {c}_{2 n} \\ ⋮ & ⋮ & ⋱ & ⋮ \\ {c}_{m 1} & {c}_{m 2} & … & {c}_{m n}\end{matrix} ] , \qquad ( 5 )$$

wherein, cᵢⱼ indicates that whether the team leader lⱼ intents to accept the team member mᵢ. cᵢⱼ satisfies the following constraints:

$$\{ \begin{matrix}{c}_{i j} ∈ \{ 0 , 1 \} \\ {c}_{i j} \leq {b}_{i j}\end{matrix} . \qquad ( 6 )$$

That is, cᵢⱼ can be 0 or 1. When cᵢⱼ=0, it may mean the team leader lⱼ has no intention to accept the team member mᵢ; When cᵢⱼ=1, it means that the team leader lⱼ intentionally accepts the team member mᵢ. In addition, because b indicates whether team member mᵢ is recommended to team leader lⱼ. When bᵢⱼ=0, i.e., team member mᵢ is not recommended to team leader lⱼ, the team leader lⱼ cannot receive the team member mᵢ, so cᵢⱼ can be set to 0. And when bᵢⱼ=1, i.e., team member mᵢ is recommended to team leader lⱼ, the team leader lⱼ can be selected according to his/her own intention, that is, c can be 0 or 1. In some embodiments, the acceptance intention matrix Q is an enumerated type, and may take any value in the set Vq, which is a set including a plurality of definite value intention matrices q. When each cᵢⱼ takes a certain value (0 or 1), the acceptance intention matrix Q becomes a definite value intention matrix q.

Based on the recommendation matrix R and the acceptance intention matrix Q, the probabilities, P_{(Q=q)}, that the acceptance intention matrix Q takes different definite value intention matrices q (denoted as Q=q) may be obtained, and the success rate for team determination, N_{(Q=q)}, when Q=q may also be obtained. In some embodiments, the expected success rate for team determination can be expressed as equation (7):

E_{(L,R)}=Σ_{q∈Vq}P_{(Q=q)}·N_{(Q=q)}, (7)

wherein, the probability of occurrence of the acceptance intention matrix Q=q can be determined by equation (8):

$${P}_{( Q = q )} = {\prod }_{{1 \leq i \leq m}_{1 \leq j \leq n}} {p}_{i j}^{{b}_{i j} {c}_{i j}} \cdot {( 1 - {p}_{i j} )}^{{b}_{i j} ( 1 - {c}_{i j} )} . \qquad ( 8 )$$

In some embodiments, a team member to be grouped may be recommended to multiple team leaders to be grouped (for example, at least two team leaders to be grouped). Assume that aᵢ indicates the number (or count) of team leaders who want to accept the team member mᵢ, then:

aᵢ=Σⱼ₌₁ⁿ[cᵢⱼ=1]. (9)

When team member mᵢ is recommended to aᵢ team leaders, and each team leader wants to accept the team member mᵢ, a relationship similar to a competitive relationship exists between the various team leaders. In some embodiments, each team leader may freely choose which team leader's team to join when several team leaders send invitation to team member mᵢ. In some embodiments, the system 100 may assign the team member mᵢ according to the order selected by each team leader. For example, which team leader first selects team member mᵢ, then the team member mᵢ may join the team leader's team by default. In this example, when team member mᵢ is recommended to aᵢ team leaders who want to accept the team member, it is considered that each team leader may have the same probability of accepting the team member mᵢ, so there are:

$${P}_{( i j \vert q )} = \{ \begin{matrix}0 , & {c}_{i j} = 0 \\ \frac{1}{{a}_{i}} , & {c}_{i j} \neq 0\end{matrix} , \qquad ( 10 )$$

wherein, P_{(ij|q)} indicates the probability that the team leader l accepts the team member mᵢ when the acceptance intention matrix Q=q.

Assume that the number (or count) of team members that the team of the team leader lⱼ lacks is sⱼ, and the number (or count) of team members recommended to the team leader lⱼ is rⱼ, wherein rⱼ≥sⱼ, sⱼ team members can be selected from rⱼ team members to form the team. Therefore, the team leader lⱼ has

$$( \begin{matrix}{r}_{j} \\ {s}_{j}\end{matrix} )$$

possible combinations to form a team. Assume that in the kth combination, the indexes of the team members received by the team leader lⱼ is expressed as {index₁, index₂, . . . indexₛ_{ⱼ}}, there are:

$$\begin{matrix}{r}_{j} = {\sum }_{i = 1}^{m} [ {b}_{i j} = 1 ] , & ( 11 ) \\ {p}_{( j \vert q )} = {\sum }_{k = 1}^{( \begin{matrix}{r}_{j} \\ {s}_{j}\end{matrix} )} {\prod }_{t = 1}^{{s}_{j}} {P}_{( {index}_{t} j \vert q )} , & ( 12 )\end{matrix}$$

wherein, p_{(j|q)} represents the probability that the team leader lⱼ determines a team in the case that the acceptance intention matrix Q=q.

According to equations (9)-(12), the expected success rate for team determination or formation may be derived as:

$${E}_{( L , R )} = {\sum }_{q ∈ Q} {P}_{( Q = q )} \cdot {N}_{( Q = q )} = {\sum }_{q ∈ Q} {P}_{( Q = q )} {\sum }_{j = 1}^{n} {p}_{( j \vert q )} = {\sum }_{q ∈ Q} {\prod }_{{1 \leq i \leq m}_{1 \leq j \leq n}} {p}_{i j}^{{b}_{i j} {c}_{i j}} \cdot {( 1 - {p}_{i j} )}^{{b}_{i j} ( 1 - {c}_{i j} )} {\sum }_{k = 1}^{( \begin{matrix}{r}_{j} \\ {s}_{j}\end{matrix} )} {\prod }_{t = 1}^{{s}_{j}} {P}_{( {index}_{t} j \vert q )} , \qquad ( 13 )$$

### Example 2

Assume that M denotes the maximum number (or count) of team members that each team allows, qᵢ denotes the number (or count) of team members that belong to the team of the team leader lᵢ, then the number (or count) of team members that the team needs is M·qᵢ. In this case, the total number (or count) of team members recommended for each team is aᵢ=a(M−qᵢ), wherein a is a constant. For example, a can be 2, indicating that the recommended number (or count) is twice of the number (or count) of lacked team members. Further assume that f_{α} (mₖ_{_{g}}) represents the probability that the team leader lᵢ can form a team successfully with the team members mₖ_{_{g}} when another (α-1) team leaders accept the team member mₖ_{_{g}}, wherein, team member mₖ_{_{g}} represents the gth team member in the kth combination. Then there are:

$$\{ \begin{matrix}{f}_{1} ( {m}_{{k}_{g}} ) = {p}_{{k}_{g} i} {\prod }_{s = 1}^{n} 1 - {p}_{{k}_{g} s} & {b}_{{k}_{g} s = 1} , s \neq i \\ {f}_{2} ( {m}_{{k}_{g}} ) = \frac{1}{2} {\sum }_{t = 1}^{n} {p}_{{k}_{g} i} {p}_{{k}_{g} t} {\prod }_{s = 1}^{n} 1 - {p}_{{k}_{g} s} & {b}_{{k}_{g} t} , {b}_{{k}_{g} t} = 1 , s \neq i \neq t \\ {f}_{3} ( {m}_{{k}_{g}} ) = \frac{1}{3} {\sum }_{t = 1}^{n} {\sum }_{u = 1}^{n} & {b}_{{k}_{g} s} , {b}_{{k}_{g} t} , {b}_{{k}_{g} u} = \\ {p}_{{k}_{g} i} {p}_{{k}_{g} t} {p}_{{k}_{g} u} {\prod }_{s = 1}^{n} 1 - {p}_{{k}_{g} s} & 1 , s \neq i \neq t \neq u \\ … & \\ … & \\ … & \\ {f}_{len ( {L}_{j} )} ( {m}_{{k}_{g}} ) = \frac{1}{len ( {L}_{j} )} {\prod }_{s = 1}^{n} {p}_{{k}_{g} s} & {b}_{{k}_{g} s} = 1\end{matrix} , \qquad ( 14 )$$

wherein, len (Lⱼ) represents the number (or count) of team leaders to which the team member mₖ_{_{g}} are recommended. Further, it may be determined that the success rate for team determination or formation relating to the team leader lᵢ and the team member mₖ_{_{g}} may be expressed as equation (15):

Σ_{α=1}^{len(L}^{ⱼ}⁾f_{α}(mₖ_{_{g}}). (15)

In some embodiments, it may be considered to be independent whether team leader lᵢ and each team member mₖ_{_{g}} may be grouped in a team. Therefore, it may be further determined that the success rate for team determination according to the kth determination may be expressed as equation (16):

Π_{g=1}^{M-q}^{ᵢ}Σ_{α=1}^{len(L}^{ⱼ}⁾f_{α}(mₖ_{_{g}}). (16)

Further, the success rate that the team leader lᵢ determines a team may be expressed as equation (17):

$${P}_{{l}_{i}} = {\sum }_{k = 1}^{{C}_{{a}_{i}}^{M - {q}_{i}}} {\prod }_{g = 1}^{M - {q}_{i}} {\sum }_{α = 1}^{len ( {L}_{j} )} {f}_{α} ( {m}_{{k}_{g}} ) . \qquad ( 17 )$$

Therefore, based on equations (14)-(17), it may be determined that the expected success rate for team determination or formation may be expressed as equation (18):

E_{(L,R)}=Σᵢ₌₁ⁿPₗ_{ᵢ}. (18)

By establishing an expectation model for determining a success rate for team determination (e.g., Example 1, Example 2), the relationship between expected success rate E_{(L,R)} and acceptance probability matrix L and recommendation matrix R may be expressed. Based on this, the team recommendation scheme (i.e., the recommendation matrix R) may be determined according to the combination optimization algorithm. In some embodiments, the combination optimization algorithm may include a genetic algorithm, an ant colony algorithm, a bee colony algorithm, a particle swarm algorithm, or the like, or any combination thereof. The present disclosure does not limit this.

In 730, the processing device 112 may determine one or more teams based on the team recommendation scheme. In some embodiments, 730 may be performed by the team determination unit 660.

In some embodiments, the team determination unit 660 may recommend (send) the information of team members to the team leader. In some embodiments, the number (or count) of team members that the team determination unit 660 recommend to a team leader may be greater than the number (or count) of team members needed for the team leader. In this case, the team leader may choose team members he/she wants from the recommended team members. In some embodiments, if the team leader selects the team members and the number (or count) of team members selected reaches t a certain threshold (such as 5, 8, 10, etc.), it may indicate that the team is successfully formed. In some embodiments, if the team leader picks up some team members and the number (or count) of team members in the team does not reach a certain threshold, it may mean that the team determination fails. In some embodiments, when the team determination fails, the corresponding team leader and team members can re-register and participate in team formation again. In some embodiments, the system 100 may keep participants in a failed team formation and recommend one or more other team members based on the number (or count) of team members lacks as another attempt to form a team.

In some embodiments, the team determination unit 660 may also recommend information of team leaders to be grouped (e.g., send) to team members to be grouped. For example, the team determination unit 660 may recommend information of a team leader to be grouped to the corresponding team members to be grouped according to a team recommendation scheme (e.g., recommendation matrix R). In some embodiments, if more than one team leader is recommended to a same team member, the team member can choose to join the team of one team leader. In some embodiments, a team leader will be recommended to a team member only if the team leader has selected the team member. In some embodiments, a two-way selection mechanism can also be employed. For example, the system 100 may recommend multiple team members to each team leader, and recommend one or more team leaders to each team member. Only when a team leader selects a team member and the team member also selects the team leader, the team member can join the team leader's team.

In some embodiments, when team is formed, the team leader and team members in the team can mutually restrain and encourage each other to provide better Internet services (such as online car-hailing service). In some embodiments, the system 100 can perform assessments on a team basis according to the performance of the team, and the team with a relative good evaluation result may be given certain rewards, thereby also motivating the drivers to actively register to determine a team.

FIG. 8 is a flowchart of an exemplary process for training an acceptance probability model according to some embodiments of the present disclosure. In some embodiments, the process 800 may be executed by the service system 100. For example, the process 800 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 800 in a service platform (e.g., the online to offline service system 100). The platform may be an Internet-based platform that connects service providers and requesters through the Internet.

In 810, the processing device 112 may obtain the historical team determination data relating to the plurality of team leaders and the plurality of team members. In some embodiments, step 810 may be performed by the information obtaining module 410.

In some embodiments, the historical team determination data may include the information and/or data that was generated in the team recommendation process and/or results. For example, the historical team determination data may include team recommendation time, team recommendation number (the number or count of team leaders and the number or count of team member number), team recommendation scheme, team leader selection result after team recommendation, team member selection result after team recommendation, team leader information, team member information, or the like, or any combination thereof. The team leader information and/or team member information may include, but is not limited to, natural attribute information, social attribute information, or habitual attribute information. The natural attribute information may include age, hometown, gender, height, weight, or the like, or any combination thereof. The social attribute information may include name, occupation, industry, family role, family information, social role, or the like, or any combination thereof. The habitual attribute information may include hobbies, specialties, habits, or the like, or any combination thereof. In some embodiments, when the team leaders and the team members are drivers, the information of the team leaders and/or information of the team members may also include the driving age of the drivers, the service level (service points), and/or vehicle type, color, brand, license plate number, capacity (such as 4 or 7 seats, etc.), additional attributes (such as panoramic sunroof), driving mileage, age, or the like, or any combination thereof.

In some embodiments, once the team formation is completed according to a team recommendation, the team recommendation can be considered as the historical team determination data. In some embodiments, the historical team determination data may include data relating to a determination of a team (or team recommendation) for a past period (e.g., 1 day, 1 week, 1 month, 3 months, half year, 1 year, etc.). In some embodiments, the historical team determination data may include data relating to the quantity of recently completed team determination (e.g., 500, 1000, 5000, etc.). In some embodiments, the historical team determination data may be data relating to a determination of a team (or team recommendation) within a region. For example, the region may include a certain country, a certain province, a certain state, a certain city, a certain area, a certain predetermined region, or the like, or any combination thereof. In some embodiments, the historical team determination data may include data that has historically been used for team recommendation, but ultimately the team formation did not success.

In 820, the processing device 112 may train an acceptance probability model using the historical team determination data. In some embodiments, step 820 may be performed by the training unit 650.

The acceptance probability model may reflect the acceptance probability of a certain type of team leaders accepting a certain type of team members. For example, for a same type of team leaders (or a same type of team members), they may have a similarity in the natural attribute information, social attribute information, habitual attribute information, or the like, or any combination thereof. In some embodiments, the acceptance probability may indicate the probability that a team leader (or a certain type of team leaders) will accept a team member (or a certain type of team members) when the team member (the certain type of team members) is recommended to the team leader (or the certain type of team leader).

In some embodiments, the training unit 650 may generate an acceptance probability model based on a machine learning algorithm based on the historical team determination data. The machine learning method may include inductive learning algorithm, reinforcement learning algorithm, deductive learning algorithm, analog learning algorithm, or the like, or any combination thereof. For example, the training unit 650 may train and obtain the acceptance probability model according to a logistic regression (LR) algorithm. In this case, the degree of influence of various types of information (such as natural attribute information, social attribute information, etc.) of team leaders and/or team members on the acceptance result (such as the weight of various types of information (or features) on the reception result) may be obtained. In some alternative embodiments, the acceptance probability model may also be obtained based on other training method, for example, a neural network, a decision tree, etc.

In some embodiments (for example, when there is not enough historical team determination data), the system 100 may also determine the acceptance probability model by other means. For example, the main factors (such as hometown, age, occupation, etc.) that a team leader considers when selecting team members (or team members) may be determined through surveys, the weight of each factor that are determined based on the survey results, and the acceptance probability model may be determined according to the weight of each factor.

After the training of the acceptance probability model is completed, the acceptance probability determination unit 610 may use the trained acceptance probability model to determine the acceptance probability between each team leader to be grouped and each team member to be grouped. In order to more clearly describe the relevant embodiments in the present disclosure, it may be assumed that there are n team leaders to be grouped {l₁, l₂, . . . , lₙ} and m n team members to be grouped {m₁, m₂, . . . , mₘ}. The acceptance probability determination unit 610 may determine the acceptance probability matrix between the n team leaders to be group and the m team members to be group using the acceptance probability model based on the information of the n team leaders to be grouped and the information of the m team members to be grouped. The acceptance probability matrix may be expressed as L:

$$L = \begin{matrix}\begin{matrix}\begin{matrix}{m}_{1} \\ {m}_{2}\end{matrix} \\ ⋮\end{matrix} \\ {m}_{4}\end{matrix} \begin{matrix} \begin{matrix}{l}_{1} & {l}_{2} & … & {l}_{n} \end{matrix} \\ [ \begin{matrix}{p}_{11} & {p}_{12} & … & {p}_{1 n} \\ {p}_{21} & {p}_{22} & … & {p}_{2 n} \\ ⋮ & ⋮ & ⋱ & ⋮ \\ {p}_{m 1} & {p}_{m 2} & … & {p}_{mn}\end{matrix} ]\end{matrix} , \qquad ( 19 )$$

wherein, pᵢⱼ denotes the probability that the team leader to be grouped lⱼ accepts the team member to be grouped m p may be any value greater than or equal to 0 and less than or equal to 1. That is, pᵢⱼ ∈[0,1]. For example, p=1 may indicate that when team member to be grouped mᵢ is recommended to the team leader to be grouped lⱼ, the team leader to be grouped lⱼ will definitely accept the team member to be grouped mᵢ. As another example, p=0 may indicate that the team leader to be grouped lⱼ will definitely not accept the team member to be grouped mᵢ. As another example, when p=0.6, it may indicate that when the team member to be grouped mᵢ is recommended to the team leader to be grouped lⱼ, the team leader to be grouped lⱼ has a probability of 60% for accepting the team member to be grouped mᵢ.

In some embodiments, the acceptance probability determination unit 610 may determine acceptance probabilities between a portion of the team leaders to be grouped and a portion of the team members to be grouped. For example, a team leader may set a condition for team determination when registering. Specifically, for example, the team leader may set that he/she will not team up with a certain type of team members (such as a team member with a smoking hobby), or set not to accept one or more team members (such as team members that are blacklisted) for teaming up, etc. In this case, the acceptance probability between the team leader and the team members (restricted team members) may not be determined; or the acceptance probability between the team leader and these team members may be set to be 0. In some embodiments, a team member may also set similar restrictions for team leaders and/or other team members.

FIG. 9 is a flowchart of another exemplary process for determining a team according to some embodiments of the present disclosure. In some embodiments, the process 900 may be executed by the service system 100. For example, the process 900 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 900 in a service platform (e.g., the online to offline service system 100). The platform may be an Internet-based platform that connects service providers and requesters through the Internet.

In 910, the processing device 112 may obtain the information of a plurality of the team participants to be grouped. In some embodiments, step 910 may be performed by the information obtaining module 410.

In some embodiments, the team participants to be grouped may include drivers (e.g., online car-hailing drivers), couriers, food deliverers, or other subjects that may relate to the system 100. In some embodiments, the team participants to be grouped may be subjects of the same work in the same place, for example, online car-hailing drivers in Shanghai. In some embodiments, the team participants to be grouped may include team leaders to be grouped and team members to be grouped.

In some embodiments, the information of team participants to be grouped may refer to attribute information of the team participants to be grouped, which may reflect features of the team participants to be grouped. The attribute information may include, but is not limited to, natural attribute information, social attribute information, or habitual attribute information. The natural attribute information may include hometown, age, personality (e.g., extroverted, open, introverted, conservative, enthusiastic, rational, etc.), gender, height, weight, or the like, or any combination thereof. The social attribute information may include a family name, a profession, an industry, a family role, a family information, a social role, or the like, or any combination thereof. The habitual attribute information may include hobbies, specialties, habits, or the like, or any combination thereof. In some embodiments, when the team participants to be grouped are drivers, the information of the team participants to be grouped can further include the driving age, service level (service points), and/or vehicle information (e.g., model, color, brand, license plate number, capacity, driving mileage, age), or the like, or any combination thereof.

In 920, the processing device 112 may determine a matching value between each pair of the plurality of team participants to be grouped based on the information of the team participants to be grouped. In some embodiments, step 920 may be performed by the matching value determination unit 630.

In some embodiments, the similarity between each pair of the team participants to be grouped may be determined based on the information of the team participants to be grouped. Further, the matching value between each pair of the team participants to be grouped may be determined based on the similarity between each pair the participation of the team participants to be grouped. In some embodiments, when the team participants to be grouped does not distinguish team leaders to be grouped or team members to be grouped, the similarity between the information of any two team participants to be grouped may be determined based on the information of any two team participants to be grouped, then the matching value between the two team participants may be determined. In some embodiments, when the team participants to be grouped are divided into team leaders to be grouped and team members to be grouped, the similarity between information of a team leader to be grouped and information of a team member to be grouped may be determined based on the information of the team leader to be grouped and the team member to be grouped. Then the matching value between the team leader to be grouped and the team member to be grouped may be further determined. Then the matching value determination unit 630 may determine the matching value between each team leader to be grouped and each team member to be grouped.

In some embodiments, the processing device 112 may compare the information of the team participants to the group (e.g., hometown information, age, character information, etc.), and determine the similarity between the information of the team participants to be grouped based on the comparison. In some embodiments, when comparing the hometown information of team participants to be grouped, if the hometowns of two team participants to be grouped are in a same county (area), it may be determined that the similarity between the hometown information of the two team participants to be grouped is very high. If the hometowns of two team participants to be grouped are in a same city but different counties (areas), it may be determined that the similarity between the hometown information of the two team participants to be grouped information is high. If the hometowns of two team participants to be grouped are in a same province but different cities, it may be determined that the similarity between the hometown information of the two team participants to be grouped is lower. If the hometowns of two team participants to be grouped are in a same country but different provinces, it may be determined that the similarity between the hometown information of the two team participants to be grouped is very low. When two team participants to be grouped in different countries, it may be determined that the similarity between the hometown information of the two team participants to be grouped is the lowest.

In some embodiments, when comparing the ages of team participants to be grouped, the age difference between the two team participants to be grouped may be determined. The smaller the age difference between the two team participants to be grouped is, the higher the similarity between the ages of the two team participants to be grouped may be. Specifically, the age difference of two team participants to be grouped may be divided into at least two different threshold intervals. The at least two different threshold intervals reflect the age difference between two team participants to be grouped. The at least two different threshold intervals may be manually set or automatically set by the system. For example, a machine learning algorithm may be used to analyze a large quantity of historical data relating to the team determination to determine the appropriate threshold intervals. For example, the age difference of the team members to be grouped may be divided into three different threshold intervals, which are respectively a first threshold interval, a second threshold interval, and a third threshold interval. The end values of the first threshold interval, the second threshold interval, and the third threshold interval may be gradually increased. For example, the first threshold interval, the second threshold interval, and the third threshold interval may be [0, 4], [5, 9], [10, 100], respectively. As another example, the first threshold interval, the second threshold interval, and the third threshold interval may be [0, 5], [6, 10], [11, 100], respectively. When the age difference of two team participants to be grouped is within the first threshold interval, it may be determined that the similarity between the ages of the two team participants to be grouped is high. When the age difference of two team participants to be grouped is within the second threshold interval, it may be determined that the similarity between the ages of the two team participants to be grouped is high. When the age difference of two team participants to be grouped is within the third threshold interval, it may be determined that the similarity between the ages of the two team participants to be grouped is lower.

In some embodiments, when comparing the character information of team members to be grouped, if two team personality to be grouped have the same character, for example, the character of the two team members to be grouped are outgoing and open, it may be determined that the similarity between the character information of the two team members to be grouped is very high. If part of the characters of two team members to be grouped are the same, for example, the character of a participant to be grouped is enthusiasm and open, and the character of another participant to be grouped is enthusiasm and conservative, and it may be determined that the similarity between the character information of the two team members to be grouped is high. If the characters of two team participants to be grouped are completely different, for example, the character of a participant to be grouped is enthusiasm and open, and the character of another participant to be grouped is introverted and conservative, and it may be determined that the similarity between the character information of the two team participants to be grouped is very low. In some embodiments, a machine learning algorithm may be used to determine the similarity of the character information of the team member to be grouped. In some embodiments, a character analysis model may be used to determine the similarity of the character information of the team participants to be grouped.

The similarity between the team participants to be grouped (for example, the similarity between the hometown information, the similarity between the ages, and the similarity between the character information) may be quantified as a specific value. In some embodiments, a higher similarity between the information of the team participants to be grouped may be quantified as a larger specific value. Instead, a lower similarity between the information of the team participants to be grouped may be quantified to a smaller specific value. In some embodiments, the specific value may be set manually or automatically by system. In some embodiments, a machine learning algorithm may be used to analyze a large quantity of historical data relating to the team determinations to determine appropriate values for the specific value.

It should be noted that the above description of comparing the hometown information, the ages, and the character information of the team participants to determine the similarity of the team participants to be grouped is merely an example, and does not limit the scope of inclusion of the present disclosure. For those skilled in the art, the matching value determination unit 630 may compare some or all of the attribute information (such as, natural attribute information, social attribute information, habitual attribute information) of the team participants to be grouped, and determine the similarity between part or all attribute information of the team participants to be grouped according to the comparison result.

In some embodiments, an evaluation function may be used to determine the similarity between two team participants. In some embodiments, a hometown evaluation function may be used to determine the similarity between the hometown information of the team participants to be grouped. The hometown evaluation function may be a piecewise function, an exponential function, a logarithmic function, or the like, or any combination thereof. In some embodiments, the hometown evaluation function may be expressed as equation (20):

$$h ( a , b ) = \{ \begin{matrix}\begin{matrix}\begin{matrix}\begin{matrix}{T}_{1} , a and b are from the same county ( district ) \\ {T}_{2} , a and b are from the same city\end{matrix} \\ {T}_{3} , a and b are from the same province\end{matrix} \\ {T}_{4} , a and b are from the same country\end{matrix} \\ {T}_{5} , a and b are from different countries\end{matrix} , \qquad ( 20 )$$

wherein, a and b respectively represent two team participants to be grouped, h(a, b) represents the hometown evaluation function, and T1, T2, . . . , T5 respectively represent the values of similarity between the team participants' hometown information. For example, T1, T2, . . . , T5 may be 5, 4, 3, 2, 1, respectively. As another example, T1, T2, . . . , T5 may be 4, 3, 2, 1, 0, respectively.

In some embodiments, when the team participants to be grouped are divided into team leaders to be grouped and team members to be grouped, the hometown evaluation function may be used to evaluate the similarity between the hometown information of each team leader to be grouped and the hometown information of each team member to be grouped hometown information. In this case, a in hometown evaluation function h (a, b) represents team leaders to be grouped, and b represents team members to be grouped.

In some embodiments, an age evaluation function may be used to determine the similarity between the ages of the team participants to be grouped. The age evaluation function may be a piecewise function, an exponential function, a logarithmic function, or the like, or any combination thereof. In some embodiments, the age evaluation function may be expressed as equation (21):

$$f ( a , b ) = \{ \begin{matrix}{R}_{1} , The age difference between a and b \\ is within the first threshold interval \\ {R}_{2} , The age difference between a and b \\ is within the second threshold interval , \\ {R}_{3} , The age difference between a and b \\ is within the third threshold interval\end{matrix} \qquad ( 21 )$$

wherein a and b respectively represent two team participants to be grouped, f(a, b) represents the age evaluation function, and R1, R2, and R3 respectively represent the values of similarity between the ages of the team participants to be grouped. For example, R1, R2, and R3 may be 3, 2, and 1, respectively. As another example, R1, R2, and R3 may be 2, 1, and 0, respectively. The end values of the first threshold interval, the second threshold interval, and the third threshold interval may be gradually increased. For example, the first threshold interval, the second threshold interval, and the third threshold interval may be [0, 4], [5, 9], [10, 100], respectively. As another example, the first threshold interval, the second threshold interval, and the third threshold interval may be [0, 5], [6, 10], [11, 100], respectively.

In some embodiments, when the team participant to be grouped are divided into team leaders to be grouped and team members to be grouped, the age evaluation function may be used to evaluate the similarity between the ages of each team leader to be grouped and each team member to be grouped. In this case, a in the age evaluation function f (a, b) represents a team leader to be grouped, and b represents a team member to be grouped.

In some embodiments, a character evaluation function may be used to determine the similarity between the character information of the team participants to be grouped. The character evaluation function may be a piecewise function, an exponential function, a logarithmic function, or the like, or any combination thereof. In some embodiments, the character evaluation function may be expressed as equation (22):

$$y ( a , b ) = \{ \begin{matrix}{Q}_{1} , a and b have the same character \\ {Q}_{2} , a and b have the similar character \\ {Q}_{3} , a and b have different characters\end{matrix} , \qquad ( 22 )$$

wherein, a and b respectively represent two team participants to be grouped, y(a, b) represents the character evaluation function, and Q1, Q2, and Q3 respectively represent values of similarity between the character information of the team participants to be grouped. For example, Q1, Q2, and Q3 may be 3, 2, and 1, respectively. As another example, Q1, Q2, and Q3 may be 2, 1, and 0, respectively.

In some embodiments, when the team participants to be grouped are divided into team leaders to be grouped and team members to be grouped, the character evaluation function may be used to evaluate the similarity between the character information of each team leader to be grouped and each team member to be grouped. In this case, a in the character evaluation function y (a, b) represents a team leader to be grouped, and b represents a team member to be grouped.

It should be noted that the above descriptions of the hometown evaluation function, the age evaluation function, and the character evaluation function are merely examples, and do not limit the scope of inclusion of the present disclosure. For those skilled in the art, the matching value determination unit 630 may determine the similarity between other aspects of the team participants to be grouped based on other evaluation functions (e.g., habit evaluation function, occupational evaluation function). The matching value determination unit 630 may also determine the similarity between the information of the team participants to be grouped based on other variants of the hometown evaluation function, the age evaluation function, or the character evaluation function.

In some embodiments, after determining the similarity between the information of one or more team participants to be grouped, the matching value between the team participants to be grouped may be determined based on the similarity between the information of the one or more team participants to be grouped. The higher the similarity between the information of the team participants to be grouped, the larger the matching value between the team participants to be grouped. Specifically, one or more components of the matching value between the team participants to be grouped may be determined based on the similarity between the information of the one or more team participants to be grouped. Further, the matching value between the team participants to be grouped may be determined according to one or more components of the matching value.

In some embodiments, when the similarity between the information of one or more team participants to be grouped is a non-quantitative value, the one or more components of the matching value between the team participants to be grouped may be determined according to the degree of the similarity between the information of the one or more team participants to be grouped. When the similarity between the information of the team participants to be grouped is high, the components of the matching value between the team participants to be grouped may be large. Conversely, when the similarity between the information of the team participants to be grouped is low, the components of the matching value of the team participants to be grouped may be small. In some embodiments, when the similarity between the information of one or more team participants to be grouped is a quantified value, one or more components of the matching value between the team participants to be grouped may be determined according to the magnitude of the quantized value. For example, a mapping relationship between the components of the matching value between the team participants to be grouped and the similarity between the information of the team participants to be grouped may be set, and one or more components of the matching value between team participants to be grouped may be determined according to the mapping relationship. For example, the mapping relationship may be that one or more components of the matching value between the team participants to be grouped may be equal to the similarity between the information of the team participants to be grouped.

In some embodiments, the matching value between the team participants to be grouped may be a simple sum of the one or more components of the matching value. In some embodiments, the matching value between the team participants to be grouped may be a weighted sum of the one or more components of the matching value. The weighting coefficients of the one or more components may be manually set or automatically set by the system. In some embodiments, a machine learning algorithm may be used to analyze a quantity of historical team determination data to determine appropriate weighting coefficients. The matching value between the team participants to be grouped may be the result of other operations of the one or more components of the matching value. Other operations may include, but are not limited to, a multiply, a reciprocal, an integral, or the like, or any combination thereof.

In some embodiments, if the matching value between the team participants to be grouped includes a first component, a second component, and a third component, the matching value between the team participants to be grouped may be determined based on the first component, the second component, or the third component. In some embodiments, the first component may be determined based on the similarity between the hometown information of the team participants to be grouped. The second component may be determined based on a similarity between the ages of the team participants to be grouped. The third component may be determined based on a similarity between the character information of the team participants to be grouped.

In some embodiments, the matching value between the team participants to be grouped may be determined based on any one of the first component, the second component, and the third component. For example, the matching value between the team participants to be grouped may be determined based on the first component. It should be noted that when the matching value between the team participants to be grouped is completely determined by the first component (i.e., the similarity between the hometown information of the team participants to be grouped), in some embodiments, the matching value between the team participants with a same hometown information (e.g., in a same county (district)), may be the highest and the probability of being assigned to a same team may be the greatest. When the team participants to be grouped are divided into team leaders to be grouped and team members to be grouped, a matching value between a team member to be grouped and a team leader to be grouped having a same hometown information (e.g., in a same county (district)) may be the highest, and the probability of being assigned to a same team may be the biggest.

In some embodiments, a matching value between the team participants to be grouped may be determined based on a component having a higher priority level of the first component, the second component, and the third component. In some embodiments, the priority levels of the first component, the second component, and the third component may be successively lowered. In the team formation, the team participants with the larger first component may be assigned to a same team, then the team participants with the larger second component of the remaining team participants to be grouped may be assigned to a same team, then the remaining team participants after the two rounds of team determination with the larger third component may be assigned to a same team. The priority levels may be manually set or automatically set by the system. In some embodiments, a machine learning algorithm may be used to analyze a quantity of the historical team determination data to determine the appropriate priority levels. In some embodiments, the matching value between the team participants to be grouped may be determined based on the first component. When the matching values between each of two or more team participants to be grouped and another team participant to be grouped are equal to each other, the matching values between each of the two or more team participants to be grouped and the another team participant to be grouped may be determined based on the second component. It should be noted that when the matching value between the team participants to be grouped is first determined according to the first component (i.e., the similarity between the hometown information of the team participants to be grouped) and then determined according to the second component (i.e., the similarity between the ages of the team participants to be grouped), in some embodiments, the matching value between the team participants with a same hometown information, (e.g., in a same county (district)), may be the highest, and the probability of being assigned to a same team is the biggest, and the probability that the team participants to be grouped having same age information are assigned to a same team may follow.

In some embodiments, the matching value between the team participants to be grouped may be determined based on any two or all of the first component, the second component, and the third component. For example, the matching value between the team participants to be grouped may be determined based on the first component and the second component, the first component and the third component, or the second component and the third component. As another example, the matching value between the team participants to be grouped may be determined based on the first component, the second component, and the third component. It should be noted that when the matching value between the team participants to be grouped is determined based on the first component, the second component, and the third component, the effects of the similarity between the hometown information of the team participants to be grouped, the similarity between the ages of the team participants to be grouped, and the character information of the team participants to be grouped on the matching value of the team participants to be grouped are considered. In some embodiments, the matching value between the team participants having similar hometown information, age information, and character information may be highest, and the probability of being assigned to a same team may be the biggest. When the team participants to be grouped are divided into team leaders to be grouped and team members to be grouped, the matching value between a team members to be grouped and a team leader having similar hometown information, age information, and character information with a team leader to be grouped may be the highest, and the probability of being assigned to a same team may be the biggest.

The similarity in the above description refers to the degree to which two or more types of information are close. For example, the first type of information is “Beijing” and the second type of information is also “Beijing”. The first type of information is exactly the same as the second type of information. The two are closest to each other, that is, the degree of similarity is the largest. It should be understood that the similarity is merely an example of indicating the proximity of two or more types of information, and is not the only example. All expressions indicating the degree to which two or more types of information are close, for example, relevance, similarity, etc., are expressed and similar, and should be included in the present disclosure.

In 930, the processing device 112 may determine one or more teams for the participants to be grouped based on the matching values between the team participants to be grouped. In some embodiments, step 930 may be performed by the team determination unit 660.

In some embodiments, the team participants may be grouped by a variety of allocation schemes. Then, based on the matching value between the team participants to be grouped (i.e., the matching value between the team participants in the already grouped teams), a plurality of allocation schemes may be selected. When the plurality of allocation schemes are used to group the team participants to be grouped, each allocation scheme may combine the team participants to be grouped into at least one team. Each team can include at least two team participants, or may include at least one team member and at least one team leader. An allocation scheme corresponds to a total sum of matching values. The sum of the total matching values may be the sum of the total matching values of all the teams in the allocation scheme. For example, when the first allocation scheme combines team participants to be grouped into three teams, and the total matching values of the three teams are 52, 85, and 43, respectively, the sum of the total matching values of the first allocation scheme is 180, that is, (52+85+43). The total matching value of a team reflects the sum of the matching values between the team participants in the team. In some embodiments, when the team participants do not distinguish team leaders and team members, the total matching value of a team refers to the sum of the matching values between any two of team participants in the team. For example, when the first team has 7 team participants s, the total matching value of the first team is the sum of the matching values between any two of the 7 team participants. In some embodiments, when the participants are divided into team leaders and a team members, the total matching value of a team refers to the sum of the matching values between the team leader and each team member in the team. For example, when the second team has 1 team leader and 6 team members, the total matching value of the second team is the sum of the matching values between the team leader and each of the 6 team members.

In some embodiments, a plurality of the allocation schemes may be selected based on the sum of the total matching values corresponding to the allocation scheme. For example, the system may select an allocation scheme with the highest sum of the total matching values to group the team participants to be grouped. For example, when the three allocation schemes are used to group the team participants to be grouped, and the sums of the total matching values corresponding to the three allocation schemes are 580, 680, and 780, respectively, the allocation scheme with the total matching value of 780 may be selected to group the team participants to be grouped.

In some embodiments, the team participants may be grouped according to a machine learning allocation scheme. First, any of the allocation schemes may be used to group the team participants to be grouped to get a plurality of initial teams. The arbitrary allocation scheme may be an artificially determined allocation scheme, or may be an allocation scheme randomly selected by the system. The plurality of initial teams may include all or part of the team participants to be grouped. Each initial team may include at least two team participants, or may include at least one team member and at least one team leader. Then, based on the matching values between the team participants to be grouped (i.e., the matching values between the team participants in the initial teams), the total matching value of each initial team may be determined. Then, based on the total matching value of each initial team, the sum of the total matching values of a plurality of initial teams may be determined. Finally, the composition of a plurality of the initial teams is continually adjusted until the sum of the total matching values of the adjusted initial teams in all possible allocation schemes is greatest. In this case, the corresponding adjusted initial alignment is the final allocation scheme. Furthermore, the final allocation scheme may be used to group the team participants to be grouped.

It should be noted that the matching value between the team participants and the matching value between the team participants to be grouped express the same content. It is only in different periods of use that different expressions are used. The matching value between team participants to be grouped is used when no team is formed before the grouping, and the matching value between the team participants is used when forming a team after grouping.

In order to fully explain the process of team formation, an example is described as follows. It should be understood that the following description is for illustrative purposes only and does not limit the scope of protection of the present disclosure.

Assume that there are m+n team participants to be grouped, the m+n team participants to be grouped consists of multiple team leaders to be grouped and multiple team members to be grouped. It can be represented by matrix A as equation (23):

$$A = [ \begin{matrix}{a}_{11} & … & {a}_{1 n} \\ ⋮ & ⋱ & ⋮ \\ {a}_{m 1} & … & {a}_{mn}\end{matrix} ] , \qquad ( 23 )$$

wherein, the matrix A has m rows and n columns, and the meaning of any element au in the matrix A is as follows:

$${a}_{i j} = \{ \begin{matrix}1 , team member j is recommended to team leader i \\ 0 , team member j is not recommended to \\ team leader i\end{matrix} . \qquad ( 24 )$$

In the process of grouping, set two constraints: (1) Up to 7 team members per team; (2) Each team member can only be recommended to 1 team leader. The two constraints may be expressed as follows:

$$\{ \begin{matrix}∀ i , {\sum }_{j = 1}^{n} {a}_{ij} \leq 7 \\ ∀ j , {\sum }_{i = 1}^{m} {a}_{ij} \leq 1\end{matrix} . \qquad ( 25 )$$

As mentioned above, when the team participants is divided into team leaders and team members, the total matching value of a team is the sum of the matching values between the team leader and each team member in the team. The matching value between the team leader and each team member in the team may be determined by one or more components of the matching value, which are determined by the similarity between the information of the team leader in the team and the information of each team member in the team. In the process of grouping, one or more evaluation functions may be used to determine the similarity between team participants to be grouped. For example, only the hometown evaluation function may used to determine the similarity between team participants to be grouped, as shown in equation (20). In this case, the matching value between the team participants to be grouped is determined by only one component, that is, only by the similarity between the hometown information of the team participants to be grouped. Assume that the similarity between the hometown information of the team participants to be grouped is equal to the component of the matching value between the team participants to be group, the total matching value of a team may be as expressed in the equation (26):

g(i)=Σⱼ₌₁ⁿh(lᵢ,aᵢⱼ), (26)

wherein the function g(i) represents the total matching value of the team whose team leader is li, h (lᵢ, aᵢⱼ) indicates the matching value between team leader li and team member aᵢⱼ (i.e., one component of the matching value corresponding to the similarity between the hometown information of the team leader ii and the team member aᵢⱼ). In this case, h(lᵢ, aᵢⱼ) also represents the similarity between the hometown information of the team leader li and the team member aᵢⱼ.

According to the above description, the following model expressed as equation (27) may be obtained:

$$\begin{matrix} t . g . max {\sum }_{i = 1}^{m} {\sum }_{j = 1}^{n} h ( {1}_{i} , {a}_{ij} ) & ( 27 ) \\ h ( a , b ) = \{ \begin{matrix}\begin{matrix}\begin{matrix}\begin{matrix}{T}_{1} , a and b are from the same county ( district ) \\ {T}_{2} , a and b are from the same city\end{matrix} \\ {T}_{3} , a and b are from the same province\end{matrix} \\ {T}_{4} , a and b are from the same country\end{matrix} \\ {T}_{5} , a and b are from different countries\end{matrix} & \\ s . t . \{ \begin{matrix}∀ i , {\sum }_{j = 1}^{n} {a}_{ij} \leq 7 \\ ∀ j , {\sum }_{i = 1}^{m} {a}_{ij} \leq 1\end{matrix} & \\ {a}_{ij} = \{ \begin{matrix}1 team member j is recommended to team leader i \\ 0 team member j is not recommended to team leader i\end{matrix} , & \end{matrix}$$

The model may be solved by using a suitable algorithm. When the sum of the total matching values of the allocation scheme is the largest, the target (or final) allocation scheme may be obtained. The target allocation scheme may be used to group m+n team participants to be grouped. The algorithm may include, but is not limited to, a genetic algorithm, an annealing algorithm, or the like, or any combination thereof.

FIG. 10 is a flowchart of another exemplary process for determining a team according to some embodiments of the present disclosure. In some embodiments, the process 1000 may be executed by the service system 100. For example, the process 1000 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 1000 in a service platform (e.g., the online to offline service system 100). The platform may be an Internet-based platform that connects service providers and requesters through the Internet.

In 1010, the processing device 112 (e.g., the information obtaining module 410) may obtain the evaluation information relating to the plurality of team participants to be grouped. In 1020, the grade group determination unit 640 may assign each of the team participants to a grade group (also referred to herein as group) based on the evaluation information relating to the each of the team participants to be grouped.

In some embodiments, the evaluation information of the team participants to be grouped may include evaluation information of the team participants to the group on the online to offline service platform, evaluation information that a service requestor provides regarding the team participants to be grouped, or the like, or any combination thereof. In some embodiments, the team participants to be grouped may be drivers (such as online car-hailing drivers). In a specific embodiment where the team participants to be grouped are drivers, the evaluation information of the team participants to be grouped may include the evaluation information of the drivers on the online car-hailing platform, the evaluation information that a passenger provides regarding the drivers, or the comprehensive rating information of the drivers, or the like, or any combination thereof.

In some embodiments, the system 100 can obtain the evaluation information of the drivers on the online car-hailing platform. For example, during the online car-hailing, drivers may submit an evaluation regarding the online car-hailing platform to the system 100 (such as server 110) via the driver terminal 140. As another example, an online car-hailing platform (such as the processing device 112) may actively initiate research on drivers and obtain evaluation information of drivers on the online car-hailing platform. In some embodiments, the online car-hailing platform may investigate the drivers through a net promoter score (NPS) survey tool. Specifically, the drivers may be recommended questions, for example, “Please rate the online car-hailing platform (0-10), the higher the score, the higher your recognition of the online car-hailing platform,” or “Would you like to recommend this online car-hailing platform to friends and colleagues (and if you like, why).” etc., to collect the response information of the drivers, then the relevant evaluation information from the driver's reply information may be extracted. In some embodiments, a semantic analysis method may be used to extract the relevant evaluation information in the driver response information.

In some embodiments, according to the evaluation information of the feedback from drivers, the drivers may be divided into different grade groups. In some embodiments, the number of the count of the grade groups may be at least two. For example, the drivers may be divided into a recommender group, a passive person group, or a detractor group according to the evaluation information of the drivers on the online car-hailing platform. Wherein, the drivers of the recommender group may have higher recognition of the online car-hailing platform, and may be a recommender of the online car-hailing platform to a certain extent; the drivers of the passive person group may have generally recognition on the online car-hailing platform. For example, they may neither recommend the platform to others nor detract the platform; the drivers of the detractor group have low recognition on the online car-hailing platform, and may detract the platform to a certain extent.

In some embodiments, the system 100 may obtain the evaluation information of passengers to drivers. In the online car-hailing service platform, each time a driver completes an order, the passenger may evaluate the performance of the driver. Specifically, the passenger may select (or input) the evaluation information (such as ratings, evaluation labels, reviews, etc.) of the driver through the passenger terminal 130. In some embodiments, passengers may score drivers. The system 100 may obtain historical evaluation information that a plurality of passengers provided on a driver and determine the final evaluation information of the driver. For example, the system 100 may obtain the scores of the drivers provided by multiple passengers (for example, 500, 1000) in the history, and determine the average score of the scores provided by the multiple passengers as the final score of the driver.

In some embodiments, according to the evaluation information of the passengers on the drivers, the drivers may be divided into one or more grade groups. In some embodiments, the number of the count of the grade groups may be at least two. For example, the drivers may be divided into a high-quality service group, a general-quality service group, or a poor-quality service group according to the evaluation information of the passengers on the drivers. In this case, drivers of different grade groups can reflect the satisfaction of passengers on the drivers. For example, a driver belonging to the high-quality service group may relate to a higher satisfaction of passengers; a driver belonging to the general-quality service group may relate to a general satisfaction of passengers; a driver belonging to the poor-quality service group may relate to a lower satisfaction of passengers.

In some embodiments, the grade group determination unit 640 may determine the grade group of the team participants to be grouped using a classification model based on the evaluation information of the team participants to be grouped. The classification model may include a decision tree, an analytic hierarchy process, a Bayesian classification algorithm, or a neural network, or the like, or any combination thereof. In some embodiments, the classification model can be trained using historical evaluation data (including historical evaluation information and corresponding labels relating to the grade groups) to obtain a classification model capable of determining a grade group of a team participant to be grouped based on the new evaluation information. In some embodiments, the grade group determination unit 640 may determine the grade group of the team participants to be grouped using the decision tree. For example, the grade group determination unit 640 may take the evaluation information of the team participants to be grouped as input and determine the grade group of the team participants to be grouped by constructing a decision tree model.

In 1030, the processing device 112 may determine one or more teams for the team participants to be grouped according to the group assignment relating to the team participants to be grouped. In some embodiments, step 1030 may be performed by the team determination unit 660.

In some embodiments, the team determination unit 660 may assign team participants of different grade groups to a same team. For example, drivers belonging to the recommender group, the passive person group, and the detractor group may be assigned to the same team. As another example, the drivers of the high-quality service group, the general-quality service group, and the poor-quality service group may be assigned to the same team. In this case, each team contains drivers that belong to at least two grade groups. Through such a team assignment, after the team is formed, the team participants in the team can be mutually restrained and encouraged. For example, the drivers of the recommender group can drive the drivers of the detractor group, so that the detractor group can provide better services and improve the understanding of the drivers in the detractor group of the online car-hailing platform. As another example, the drivers of the high-quality service group can drive the drivers of the poor-quality service group to improve the quality of service of the poor-quality service group.

In some embodiments, the team determination unit 660 may assign team participants of the same grade group to a team. For example, the team determination unit 660 can assign drivers belonging to the recommender group to the same team, assign drivers belonging to the passive person group to the same team, and assign drivers belonging to the detractor group to the same team. As another example, the team determination unit 660 can assign drivers belonging to the high-quality service group to the same team, assign drivers belonging to the general-quality service group to the same team, and assign drivers belonging to the poor-quality service group to the same team. In this case, because the drivers of the same team have similar understanding, they can get along better with each other, which helps to improve the cohesiveness of the team.

In some embodiments, the team determination unit 660 may also be teamed up in combination with other factors based on the grade group of the team participants to be grouped when the team participants are to be grouped. For example, the team determination unit 660 may team up the team participants in conjunction with other embodiments disclosed in the present disclosure. For example, the team determination unit 660 may determine one or more teams for the team participants to be grouped based on the grade group of the team participants and one or more attribute information such as the hometown information, age information, or jobs of the team participants.

FIG. 11 is a block diagram illustrating another exemplary team determination module according to some embodiments of the present disclosure. The team determination module 420 may include a driving behavior characteristic determination unit 1110, the driver group determination unit 1120, and the team determination unit 1130. The modules may be hardware circuits of all or part of team determination module 420. The modules may also be implemented as an application or set of instructions read and executed by the team determination module 420. Further, the modules may be any combination of the hardware circuits and the application/instructions. For example, the modules may be the part of the processing device 112 when the team determination module 420 is executing the application/set of instructions.

The driving behavior characteristic determination unit 1110 may calculate the driving behavior characteristic of each driver according to the historical order information. The driving behavior characteristic determination unit 1110 may also calculate the characteristic of working time and/or the characteristic of driving region of each driver based on the historical order information. Wherein, the characteristic of working time may include: distribution information of the order accepting time in at least one first preset time period within one day, and/or distribution information of the order accepting time in at least one second preset time period within one week. The characteristic of driving region may include: distribution information of the order accepting location in at least one preset area within a preset geographical area. The first preset time period may includes a morning peak period or an evening peak period, or the like; and the second preset period is any one day of a week.

The driver group determining unit 1120 may group the drivers according to the driving behavior characteristic of each driver to generate at least two driver groups. The driver group determination unit 1120 may also calculate the similarity of the driving behaviors of each two drivers according to the driving behavior characteristic of each driver. The driver group determination unit 1120 may also group drivers according to the similarity of the driving behaviors of each two drivers, and generate at least two driver groups.

The team determination unit 1130 may assign the drivers in each driver group into at least one team. The team determination unit 1130 may also obtain the role of each driver in the driver group. The roles of the drivers may include a team leader and a team member. The information of team members in the same driver group may be sent to the team leader in the driver group to request that the team leader may provide a feedback indicating whether the team leader allows a team member to join his/her team. The result may include an identification of the team leader and an identification of the team member that has successfully joined. The team determination unit 1130 may also receive the result from a team leader and assign the drivers corresponding to the identifications joined successfully to his/her team

FIG. 12 is a flowchart of another exemplary process for determining a team according to some embodiments of the present disclosure. In some embodiments, the process 1200 may be executed by the service system 100. For example, the process 1200 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 1200 in a service platform (e.g., the online to offline service system 100). The platform may be an Internet-based platform that connects service providers and requesters through the Internet.

In 1210, the processing device 112 (e.g., the information obtaining module 410) may obtain historical order information relating to each of the plurality of team participants to be grouped. The historical order information may include information of drivers, order accepting time, or order accepting location. In some embodiments, the historical order information may also include information of passengers, starting location, destination location, starting time to the starting location, time to reach the destination location, payment information, or the like, or any combination thereof. The historical order information may also include all the information contained in the historical order, as well as other required information. Wherein, the order accepting location may be a real-time location of a driver recorded when a driver accepts the order, or the starting location in the historical order information may be used as the order accepting location.

In 1220, the processing device 112 (e.g., the driving behavior characteristic determination unit 1110) may determine the driving behavior characteristic for each of the plurality of participants (e.g., drivers) based on the historical order information relating to each of the plurality of participants. In some embodiments, the driving behavior characteristic of the drivers may include a characteristic of working time and/or a characteristic of driving region.

In some embodiments, some of the drivers registered in the online car-hailing platform are part-time drivers, and part-time drivers also have other jobs. The time of departure for this kind of drivers may be concentrated on one or several time periods of one day, or concentrated on one day or several days of one week. In some embodiments, some drivers are full-time drivers, but may need to go to school to pick up children at a fixed time on each day. Therefore, different drivers' departure time may have different features.

In some embodiments, the driving behavior characteristic determination unit 1110 may calculate the characteristic of working time of drivers according to the historical order information of each driver. The characteristic of working time may indicate which time period and/or days of a week a driver's order accepting time is concentrated on one day. The characteristic of working time may also include the time the drivers go online every day, the first order accepting time every day and so on. For example, the working time of the drivers may be the morning peak period and the evening peak period, or it may be Saturday and Sunday in a week. In addition, because each driver's address is different, the driver's order accepting location may have a certain regional characteristic. In some embodiments, the driving behavior characteristic determination unit 1110 may also calculate the characteristic of driving region of the driver according to the historical order information of each driver. The characteristic of driving region may indicate the geographical extent of the driver's order accepting locations. For example, the characteristic of driving region of a driver may be concentrated in the Chaoyang District and Tongzhou District in Beijing, and the characteristic of driving region of another driver may be concentrated in the five-ring region of Beijing.

In 1230, the processing device 112 (e.g., the driver group determination unit 1120) may divide the drivers into one or more driver groups based on the driving behavior characteristic of each driver. After calculating the driving behavior characteristic of each driver, the driver group determination unit 1120 may divided the drivers according to the similarity of drivers' driving behavior characteristics, so that the driver's behaviors in a same group may be similar, and the drivers in a same group may have more common topics and are more familiar and familiar with each other.

In 1240, the processing device 112 (e.g., the team determination unit 1130) may determine at least one team (also referred to herein as driver team) for each driver group. In some embodiments, each driver can only join one driver team. The drivers in each driver group may be divided into several driver teams according to a preset number (or count) of people in each team. The driving behavior characteristic between people of each driver team is relatively similar and the people of a same driver team may have more common topics, which may better supervise and encourage each other and increase the number (or count) of accepting orders. The system may pre-set the number (or count) of people per team, and may set the minimum and/or upper limit for each team. For example, the system may set each team to be 5 people, or the system may set a minimum of 4 people per team, or the system may set a minimum of 4 people and a maximum of 6 people per team.

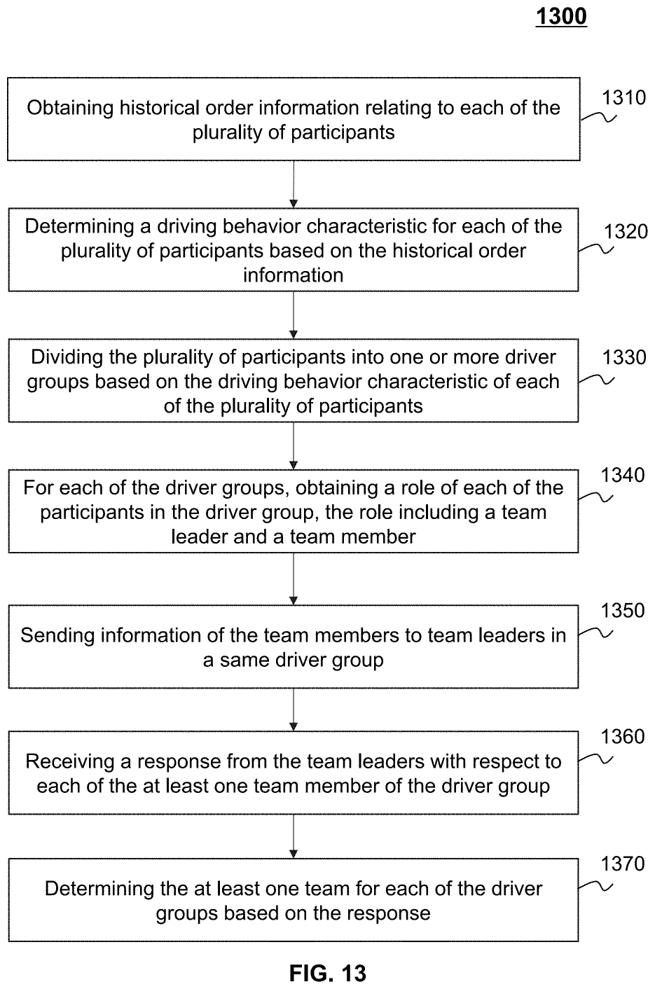

FIG. 13 is a flowchart of another exemplary process for determining a team according to some embodiments of the present disclosure. In some embodiments, the process 1300 may be executed by the service system 100. For example, the process 1300 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 1300 in a service platform (e.g., the online to offline service system 100). The platform may be an Internet-based platform that connects service providers and requesters through the Internet.

In 1310, the processing device 112 (e.g., the information obtaining module 410) may obtain historical order information relating to each of the plurality of participants (e.g., drivers) to be grouped. In some embodiments, the historical order information may relate to historical orders in a preset time period (e.g., one past month, several past months, one years, etc.).

In 1320, the processing device 112 (e.g., the driving behavior characteristic determination unit 1110) may determine the driving behavior characteristic of each of the plurality of participants based on the historical order information relating to each of the plurality of participants.

In 1330, the processing device 112 (e.g., the driver group determination unit 1120) may divide the drivers into one or more driver groups according to the driving behavior characteristic of each driver.

After determining the driving behavior characteristic of each driver, the processing device 112 may group the drivers according to the similarity of the driving behavior characteristics of the drivers, so that the driver's behavior in each group is similar, and the drivers in a same group have more common topics and are more familiar with each other. In some embodiments, the processing device 112 may determine concentrated driving time periods and/or concentrated driving regions that a driver work in according to the characteristic of working time and/or the characteristic of driving region of the driver. All drivers in each driver group may have common concentrated driving time periods and/or common concentrated driving regions.

In some embodiments, the processing device 112 may designate the time periods during which the number (or count) of times a driver works exceeds a first preset number (or count) of times as the concentrated driving time period of the driver, and the processing device 112 may designate the region in which the number (or count) of times a driver works exceeds a second preset number (or count) as the concentrated driving region of the driver. Wherein, the first preset number (or count) of times and the second preset number (or count) of times may be set according to actual and/or real-time needs, and is not specifically limited herein.

The concentrated driving time period may include one or more first preset time periods and/or second preset time periods. The concentrated driving region may include one or more preset areas.

In some embodiments, the processing device 112 may also group the drivers according to the characteristic of working time only, and all the drivers in each driver group may have a common concentrated driving time period, or all drivers in each driver group may have completely same concentrated driving time periods.

In some embodiments, the processing device 112 may group the drivers according to only the characteristic of driving region, and all the drivers in each driver group may have a common concentrated driving region, or all the drivers in each driver group may have completely same concentrated driving region.

In some embodiments, the processing device 112 may group the drivers according to the characteristic of working time and the characteristic of driving region, and all the drivers in each driver group may have a common concentrated driving time period and a common concentrated driving region, or all the drivers in each driver group may have completely same concentrated driving time periods and completely same concentrated driving regions.

In order to group the drivers according to the characteristic of working time and the characteristic of driving region, all the drivers in each driver group may have a common concentrated driving time period of the vehicle and a common concentrated driving region. For example, the concentrated driving time period of driver 1 is the morning peak period, and the concentrated driving regions of driver 1 are Chaoyang District and Haidian District; the concentrated driving time periods of driver 2 are the morning peak period and the evening peak period, and the concentrated driving regions of driver 2 are Chaoyang District and Changping District; the concentrated driving time period of drivers 3 is evening peak time, and the concentrated driving region of driver 3 is Changping District and Haidian District; then, when grouping, the processing device 112 may assign drivers 1 and drivers 2 to the same group and drivers 1 and driver 3 to the same group.

In some embodiments, according to the driving behavior characteristic of each driver, the processing device 112 may calculate the similarity of the driving behavior of each two drivers.

In some embodiments, the processing device 112 may calculate the similarity of the driving behavior of each two drivers according to the driving behavior characteristic of each driver. After calculating the driving behavior characteristic of each driver, the processing device 112 may group the drivers according to the similarity of the driving behavior characteristic of the drivers so that the driver's behavior in each group is similar, and the drivers may have more common topics and are more familiar with each other.

Specifically, for any two drivers, the processing device 112 may calculate the similarity of the working times (also referred to herein working time similarity) of the two drivers according to the characteristics of working time of the two drivers, and may calculate the similarity of driving regions (also referred to herein driving region similarity) of the two drivers according to the characteristics of driving region of the two drivers, and may calculate the similarity of the driving behavior of the two drivers based on preset weights of the characteristics of working time and the characteristics of driving region.

In some embodiments, the processing device 112 may determine a weighted average or weighted sum of the working time similarity and the driving region similarity, and designate the weighted average or the weighted sum as the driving behavior similarity of the two drivers.

In some embodiments, for any two drivers, the processing device 112 may also generate a driving attribute vector of the two drivers according to the characteristics of working time and the characteristics of driving region of the two drivers. The driving behavior similarity may be determined by calculating the distance between the driving vehicle attribute vectors of the two drivers. In addition, other similarities may also be used to express the similarity of drivers' driving behavior, such as Euclidean Distance, Cosine similarity, etc.

In some embodiments, the grouping of the drivers may be fuzzy grouping, that is, each driver may simultaneously belong to a plurality of different groups.

In some embodiments, the processing device 112 may divide the drivers in each driver group into several driver teams according to a predetermined range of the number (or count) of people in each team. The driving behavior characteristic between members of each driver team is relatively similar, and they may have more common topics, which may better supervise and encourage each other and increase the number (or count) of accepting the orders.

In some embodiments, the processing device 112 may separately determine teams for drivers in each driver group by recommending drivers to the team leader. In some embodiments, the drivers may be randomly assigned to the driver groups by the online car-hailing platform according to a preset number (or count) of people in each team.

In 1340, for each driver group, the processing device 112 may obtain a role of each driver in the driver group. A driver's role may include a team leader or a team member. Wherein, a driver may apply to be a team leader through the interface of an application provided by the online car-hailing platform. Alternatively, the team leader may be selected by the online car-hailing platform and approved by the driver.

In 1350, the processing device 112 may send the information of the team members to one or more team leaders in a same driver group. When a team leader receives the information of recommended team members, the team leader may make a response to feedback a result indicating whether the team leader allows the team members to join his/her team. The result may include an identification of the team leader and identifications of the team members that have successfully joined the team.

In some embodiments, the processing device 112 may send information of a preset numbers of team members to the team leader each time. The preset number may be set based on a predetermined number (or count) of people per team. In some embodiments, the preset number (or count) may be greater than the predetermined number (or count) of people per team, which may improve the efficiency of team formation.

In some embodiments, the information relating to a team member may be encrypted by the device of the team member. The processing device 112 may decrypted the encrypted request after receiving the encrypted information. Merely by way of example, the device of the team member may encrypt the information using its private key and/or digitally sign the request. The processing device 112 may decrypt the information using a public key of the device. In some embodiments, the encrypted information may include authentication information related to the device of the team member and/or the team member, such as an identification of the team member, a password inputted by the team member, and/or a digital signature of the device of the team member. The processing device 112 may verify the authentication information of the device of the team member and/or the team member before the decrypting.

In some embodiments, the online car-hailing platform may send a grouping message to the driver terminal 140 of the team leader, and the grouping message may includes information of the team members recommended to the team leader.

In 1360, the processing device 112 may receive a response from the team leader with respect to each of the at least one team member of each driver group.

In some embodiments, the response from the team leader may be encrypted by the device of the team leader. The processing device 112 may decrypted the encrypted response from the team leader after receiving the encrypted response from the team leader. Merely by way of example, the device of the team leader may encrypt the response from the team leader using its private key and/or digitally sign the request. The processing device 112 may decrypt the response from the team leader using a public key of the device. In some embodiments, the encrypted response from the team leader may include authentication information related to the device of the team leader and/or the team leader, such as an identification of the team leader, a password inputted by the team leader, and/or a digital signature of the device of the team leader. The processing device 112 may verify the authentication information of the device of the team leader and/or the team leader before the decrypting.

In 1370, the processing device 112 may determine the at least one team for each of the driver groups based on the response. In some embodiments, the processing device 112 may add the drivers corresponding to the member identification successfully joined to the driver team corresponding to the leader identification according to the response.

In some embodiments, if the processing device 112 determines that a team leader's team has been formed, the processing device 112 will no longer recommend information of members to the team leader. If a team member has successfully joins a team, the online car-hailing platform will not recommend the information of the team member to other team leaders.

In some embodiments, the processing device 112 may perform capacity rankings and rewards in units of driver teams to further improve driver activity and enthusiasm of accepting orders. Specifically, the processing device 112 may calculate the number (or count) of orders accepted by each driver team in a preset time range, and issue a reward to the team whose quantity of accepting orders is greater than a preset number in the preset time range. In some embodiments, the drivers may also be ranked and rewarded in the team.

In the present disclosure, the processing device 112 forms a team by organizing drivers with higher similar driving behavior characteristics. The working mode of drivers changes from the individual job to the team job. Drivers of each team may monitor and encourage each other to increase the capacity of each driver of the team. Therefore, the overall capacity of the online car-hailing platform is improved. Besides, the online car-hailing platform may determine the team leader according to the preference of each driver, and after forming the teams, the drivers who belong to the same group are recommended to the team leader of the same group, and the team leader may select the team members to complete the team determination, thereby making the process of team formation more user friendly by allowing a team leader to participate in the process.

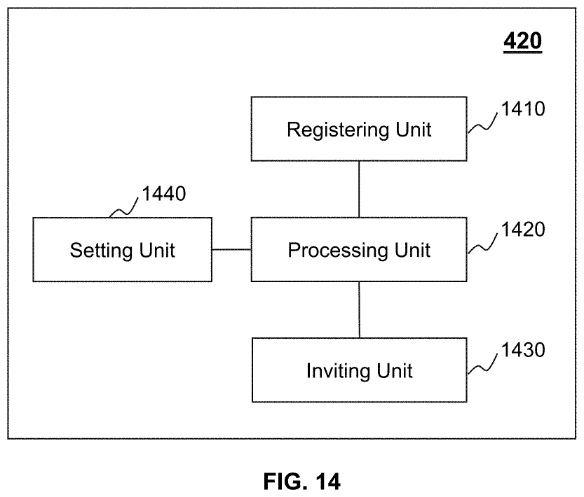

FIG. 14 is a block diagram illustrating another exemplary team determination module according to some embodiments of the present disclosure. The team determination module 420 may include a registering unit 1410, a processing unit 1420, an inviting unit 1430, and a setting unit 1440. The modules may be hardware circuits of all or part of team determination module 420. The modules may also be implemented as an application or set of instructions read and executed by the team determination module 420. Further, the modules may be any combination of the hardware circuits and the application/instructions. For example, the modules may be the part of the processing device 112 when the team determination module 420 is executing the application/set of instructions.

The registering unit 1410 may receive the registration instruction entered by a plurality of team participants (also referred to herein as users) via first interface of devices of the team participants. The type of the registration instruction may include a leader registration instruction or a member registration instruction. The registering unit 1410 may also cause activity information corresponding to the type of the registration instruction to be displayed on a fifth interface of the devices. The activity information may include responsibility information, task information, reward information, or the like, or any combination thereof.

The processing unit 1420 may determine the type of the registration instruction. If the type of the registration instruction is a leader registration instruction, the processing unit 1420 may identify one or more candidate team member from the plurality of participants according to the leader registration instruction, and cause the user information relating to the one or more candidate team members to be displayed on the second interface. For example, the processing unit 1420 may generate a request for the candidate team member according to the leader registration instruction and the information of the users. The processing unit 1420 may determine the candidate team members based on the request for determining the candidate team members and the information of the users. If the type of the registration instruction is a member registration instruction, the processing unit 1420 may further receive the user information input by the user through the personal information setting interface. The user information may include behavioral habit information and/or natural attribute information. The processing unit 1420 may further determine one or more teams according to the member registration instruction and the information of the users.

The inviting unit 1430 may be configured to send a first invitation to the candidate team members after the user selects any of the candidate team members through the second interface. The first invitation may be a preset information or an information input by the user. After the selected team members accepts the first invitation, the user information of the candidate team members that have accepted the first invitation and agree to join the team may be displayed on the third interface. The inviting unit 1430 may also determine whether a count of candidate team members that agree to join the team reaches or exceeds a predetermined value, and if so, generates a notification indicating the team has been formed successfully. The inviting unit 1430 may also send the notification f to each candidate team member that agrees to join the team, and cause the notification to be displayed on the third interface.

The setting unit 1440 may be configured to display a personal information setting interface, and receive user information input by the user through the personal information setting interface. The user information may include behavior habit information and/or natural attribute information.

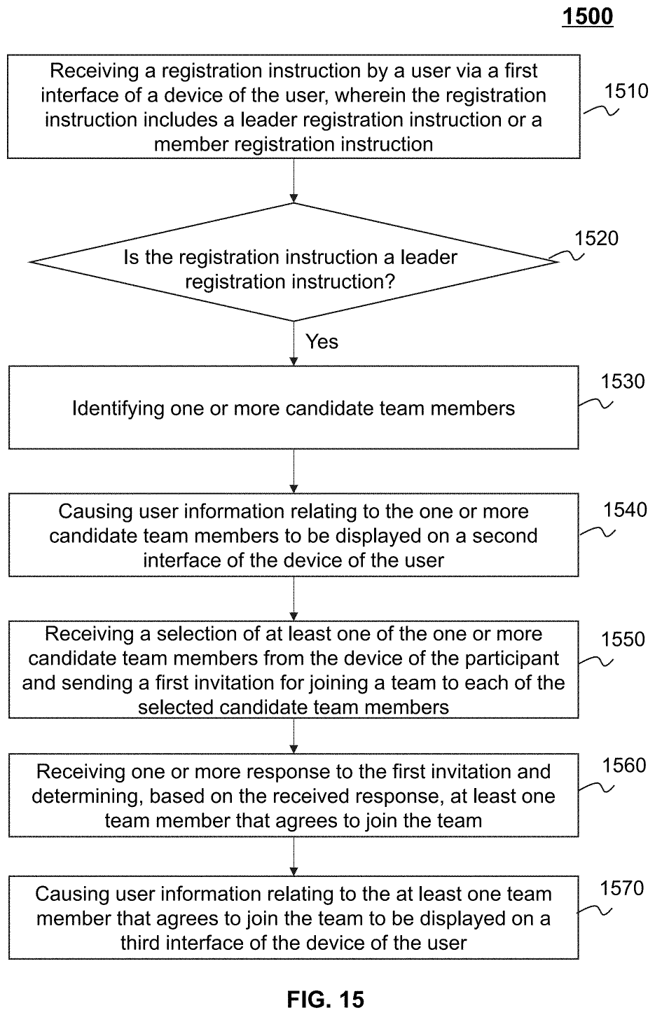

FIG. 15 is a flowchart of another exemplary process for determining a team according to some embodiments of the present disclosure. In some embodiments, the process 1500 may be executed by the service system 100. For example, the process 1500 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 1500 in a service platform (e.g., the online to offline service system 100). The platform may be an Internet-based platform that connects service providers and requesters through the Internet.

In 1510, the processing device 112 (e.g., the registering unit 1410) may receive the registration instruction entered by a user through the first interface of a device of the user. The type of the registration instruction may include a leader registration instruction or a member registration instruction.

In some embodiments, the user can set the input registration instruction through the first interface of the device of the user. The specific first interface may be set with a button for registering to be a team leader and a button for registering to be a team member. The user may input the registration instruction by clicking the button for registering to be a team leader or the button for registering to be a team member. In some embodiments, the user may also input the registration instruction by other means.

In some embodiments, the activity information corresponding to the type of the registration instruction may also be displayed on the first interface. The activity information may include the responsibility information, the task information, the reward information, or the like, or any combination thereof. In some embodiments, the activity information corresponding to the type of the registration instruction may be displayed on other interface of the device after the type of the registration instruction is determined. The responsibility information may include, responsibility of the team leader (e.g., determining and leading a team, helping team members solve problems, mobilizing enthusiasm, resolving negative emotions, etc.), responsibility of the team member (e.g., cooperating with the team leader, assisting in determining a team, actively completing tasks, etc.), or the like, or any combination thereof. The task information may include a target flow to be completed, a target amount of orders to be completed, or target service score values, etc. The task information may be set according to an activity rule or may be set by each driver team. In some embodiments, the rule information may be different for different competition activities. Before the user inputs the registration instruction, the operation of selecting the competition format may be included, and the names of various competition formats such as the PK game, the ranking game, etc., and the corresponding rule information, such as the “PK game rules: During the event, the number (or count) of orders relating to a complaint in a team is less than 10, and the number (or count) of orders relating to a service score that is smaller than the predetermined score is less than 10 in a team” may be displayed on a competition selection interface. The competition selection interface may also include a register entry for each competition format, and the user may click on the register entry to display the first interface corresponding to the competition format. The reward information may relate to give a driver team a certain price reward after completing the task. The reward rule may be specified according to the competition format. For example, the top 3 teams will receive a total of 1,000 yuan after the event. The competition selection interface may also include options for feedback, event sharing, or the like, or any combination thereof.

In 1520, the processing device 112 (e.g., the processing unit 1420) may determine whether the type of registration instruction is a leader registration instruction. When the type of the registration instruction is a leader registration instruction, then in 1530, the processing device 112 may identify one or more candidate team members according to the leader registration instruction. In 1540, the processing device 112 may cause the user information of the one or more candidate team members to be displayed on the second interface of the device of the user.

In some embodiments, the processing device 112 may determine the type of the registration instruction after receiving the registration instruction input by the user through the first interface. If the type of registration instruction is a leader registration instruction, the processing device 112 may match to determine the candidate team members for the user. The matching process may include obtaining the information of the user first, and selecting one or more using having user information similar to the user among t a plurality of the registered users. Wherein, the user information may be input by users through the devices of the users and sent to the processing device 112, or may be obtained according to the historical data of the users. The user information may include behavioral habit information and/or natural attribute information. The behavioral habit information may include the working time of a driver, driving regions, etc. The natural attribute information may include age, gender, native place of a driver, or the like, or any combination thereof. The processing device 112 may match the users with a registered user. After the processing device 112 completes the matching, the user information of the candidate team members may be sent to the device of the user, and the device of the user may display the user information of the candidate team members on the second interface for the user to select the team members. In some embodiments, the second interface may also be set with an option for inviting friends. When the user clicks on the option, the device of the user may obtain the user's friend list, and the user may select one friend in the friend list to send an invitation.

In 1550, the processing device 112 may receive a selection of at least one team member from the candidate team members from the user device, and the processing device 112 (e.g., the inviting unit 1430) may send the first invitation to the selected at least one candidate team member to join the team. The first invitation may be preset information or information input by the user.

In some embodiments, the processing device 112 may encrypt the first invitation. The processing device 112 may further transmit the encrypted first invitation to the device of the selected at least one candidate team member to join the team. For example, the processing device 112 may encrypt the first invitation using a public key of the device of the selected at least one candidate team member to join the team. The device of the team member may decrypt the encrypted first invitation using a private key of the device of the selected at least one candidate team member to join the team. In some embodiments, the encrypted first invitation may include authentication information related to the selected at least one candidate team member to join the team and/or the device of the selected at least one candidate team member to join the team to authenticate the selected at least one candidate team member to join the team and/or the device of the selected at least one candidate team member to join the team.

In 1560, the processing device 112 may receive one or more responses to the first invitation and determine at least one team member that agrees to join the team based on the response.

In 1570, the processing device 112 may cause the user information of the candidate team member that agrees to join the team to be displayed on the third interface of the device of the user.

In some embodiments, the user can select any candidate team member on the second interface and send the first invitation to the candidate team member. Specifically, the user can establish instant communication with the candidate team member after selecting any candidate team member e.g., via WeChat, QQ or instant messaging software integrated in the taxi-hailing software. The user may also communicate with the candidate team member by calling or other means. When the candidate team member accepts the invitation and agrees to join the team, the device of the user may display the user information of the candidate team member that has accepted the invitation and agrees to join the team on the third interface. Further, the team formation is completed when the number (or count) of candidate team members that have accepted the invitation and agrees to join the team reaches or exceeds a predetermined number (or count). In some embodiments, after viewing the user information of the candidate team member, the user can send the first invitation to any candidate team member according to the will, and the candidate team member can choose whether to accept the invitation according to the will.

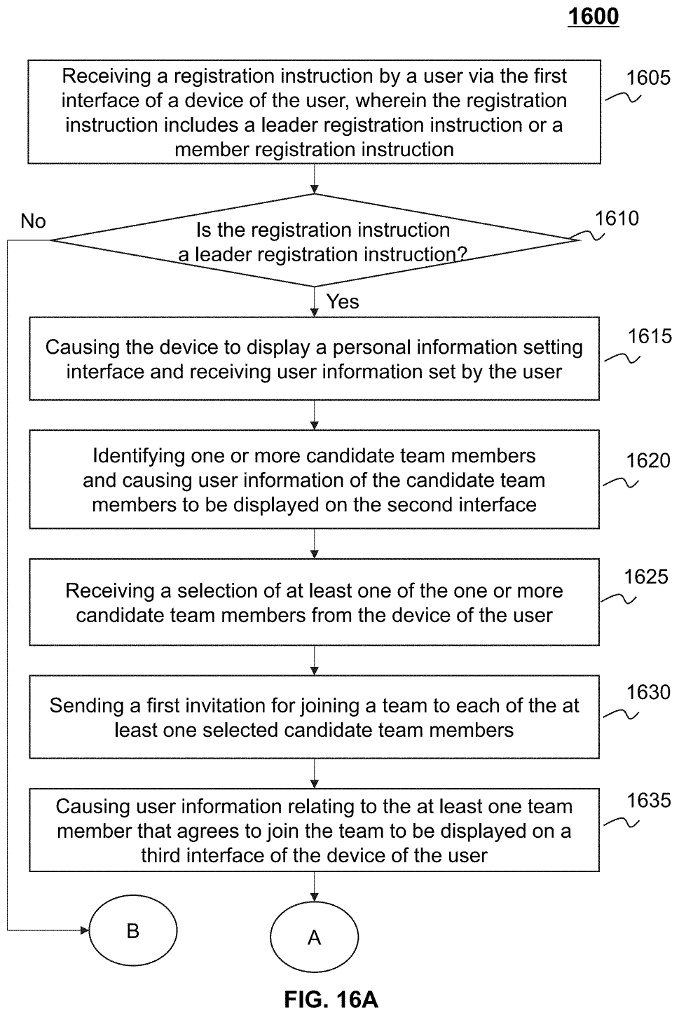

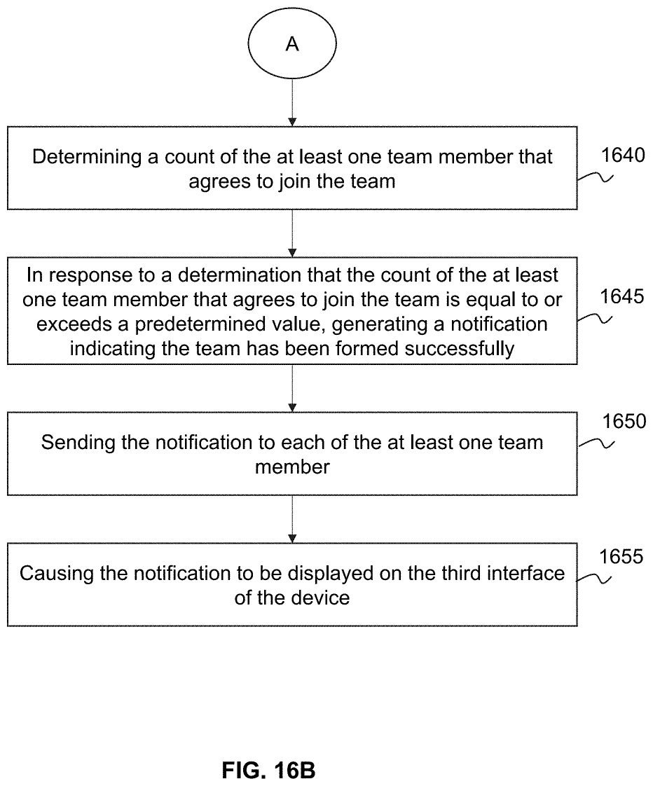

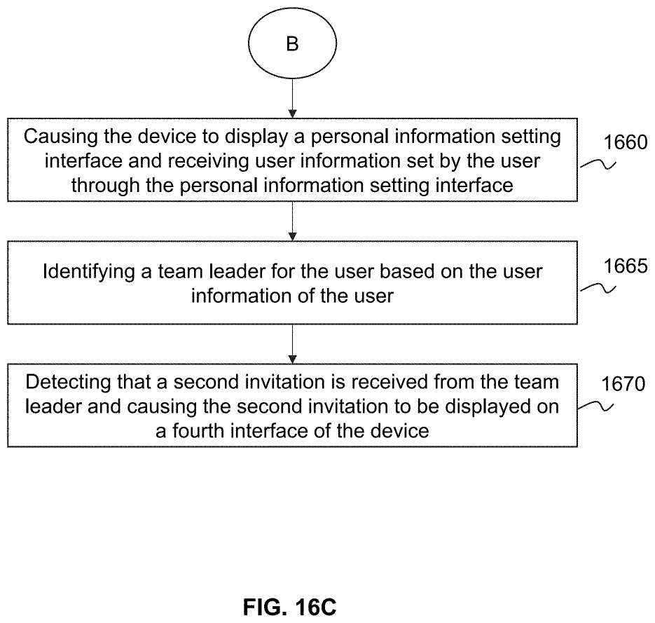

FIGS. 16A through 16C are flowcharts of another exemplary process for determining a team according to some embodiments of the present disclosure. In some embodiments, the process 1600 may be executed by the service system 100. For example, the process 1600 may be implemented as a set of instructions (e.g., an application) stored in a storage device (e.g., the storage device 150, the ROM 230, the RAM 240, the storage device 390). In some embodiments, the processing device 112 (e.g., the processor 220 of the computing device 200, the CPU 340 of the mobile device 300-1, and/or one or more modules illustrated in FIG. 4) may execute the set of instructions and may accordingly be directed to perform the process 1600 in a service platform (e.g., the online to offline service system 100). The platform may be an Internet-based platform that connects service providers and requesters through the Internet.

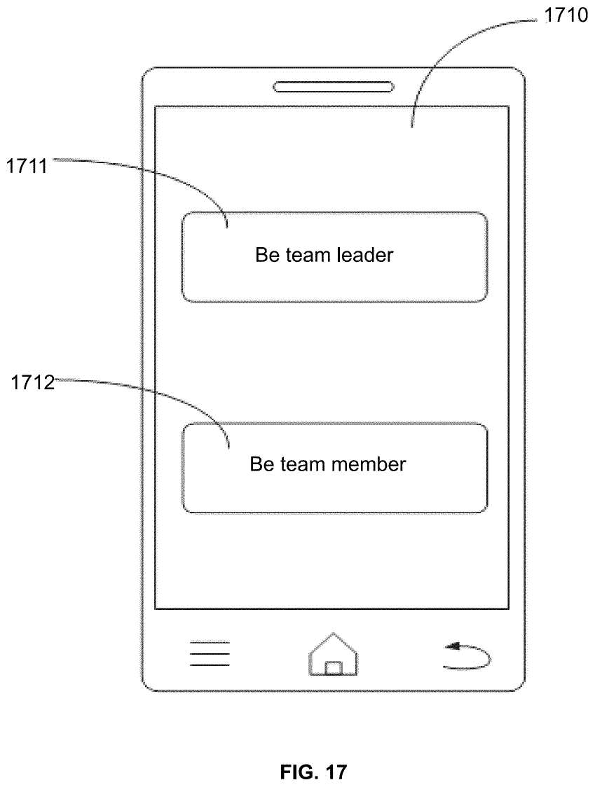

In 1605, the processing device 112 may receive the registration instruction entered by the user on the first interface. The registration instruction may include a leader registration instruction or a member registration instruction. The first interface may be shown as FIG. 17. The first interface 1710 is provided with a button 1711 for registering to be a team leader and a button 1712 for registering to be a team member. In some embodiments, the first interface 1710 may further be set activity information such as the responsibility information, the task information, or the reward information.

In 1610, the processing device 112 may determine whether the type of the registration instruction is a leader registration instruction. If the type of the registration instruction is a leader registration instruction, the process 1600 may proceed to 1615; if the type of the registration instruction is a member registration instruction, then 1660 may be performed.

Further, after determining the type of the registration instruction, the method may further include: causing activity information to be displayed on the fifth interface corresponding to the type of the registration instruction.

In 1615, the processing device 112 can cause the user device to display a personal information setting interface and receive user information entered by the user on the personal information setting interface. The user information may include behavioral habit information and/or natural attribute information.

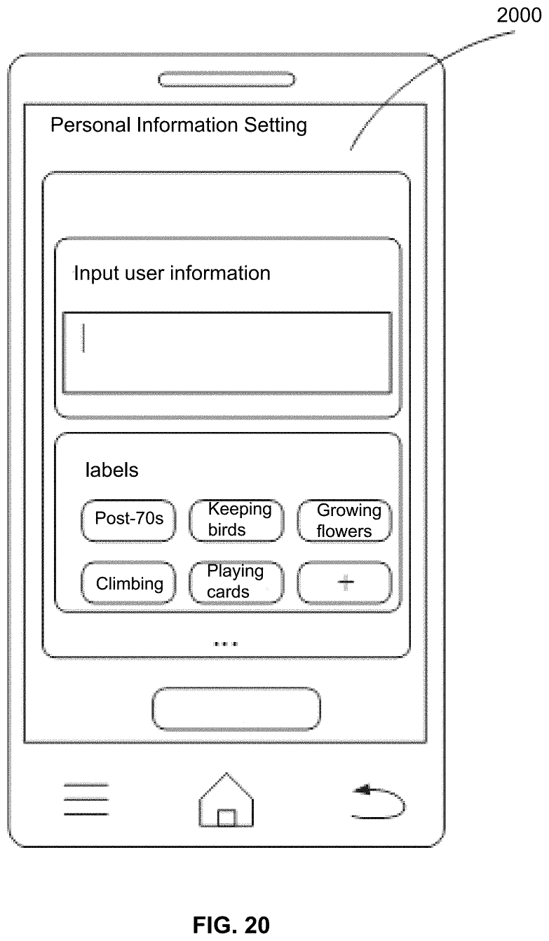

In some embodiments, the personal information setting interface may be shown as FIG. 20, and the input box may be set on the personal information setting interface 2000. After registering to be a team leader, the user may enter user information through the personal information setting interface. The user information may include behavioral habit information and/or natural attribute information. The behavior habit information may includes working times of the user, driving regions of the user, etc. The natural attribute information may includes age, gender, native place, hobbies of the user, or the like, or any combination thereof. In some embodiments, some labels may also be provided on the personal information setting interface for users to choose, such as post-70s, post-80s, keeping birds, playing mahjong, growing flowers, fighting landlords, climbing, and so on. The user information may be used for the matching process of the server, or may be displayed to the candidate team members so that the candidate team member can decide whether to accept the invitation and agree to join the team.

In 1620, the processing device 112 may identify one or more candidate team members and cause user information of the candidate team member to be displayed on the second interface of the device.

For example, the processing device 112 may generate a request for determining the candidate team member according to the team leader registration instruction and the information of the users. Then, the processing device 112 may match the candidate team member according to the information of the users. The user information of a plurality of the candidate team members returned by the processing device 112 may be displayed on the second interface of the device of the user.

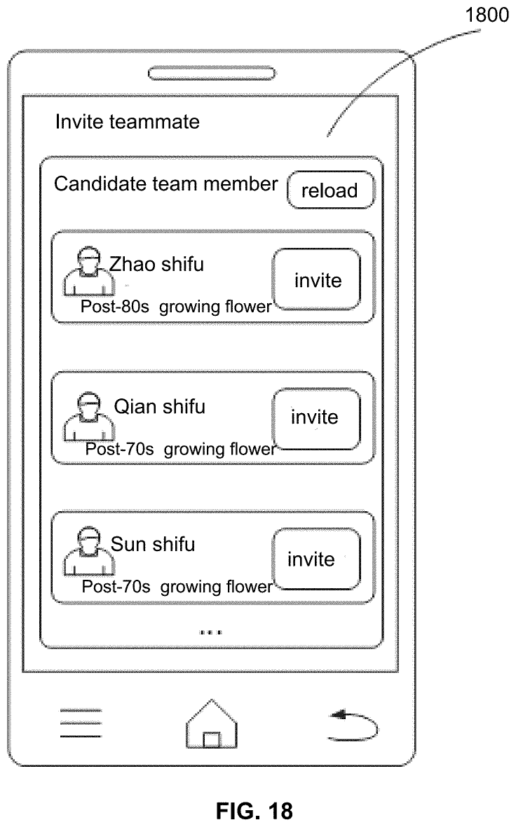

In some embodiments, the second interface may be as shown in FIG. 18. The user information of a plurality of the candidate team members may be displayed on the second interface 1800. In some embodiments, all the user information may be displayed. In some embodiments, only part of the user information may be displayed. In some embodiments, if only the labels are displayed, when clicking on the labels, all or part of the user information of the candidate team members may be displayed.

In 1625, the processing device 112 may receive a selection of at least one of the one or more candidate team members from the device of the user. In 1630, the processing device 112 may send a first invitation for joining a team to each of the at least one selected candidate team members. The first invitation may be predetermined information or information set by users. In 1635, the processing device 112 may cause user information relating to the at least one team member that agrees to join the team to be displayed on a third interface of the device of the user.

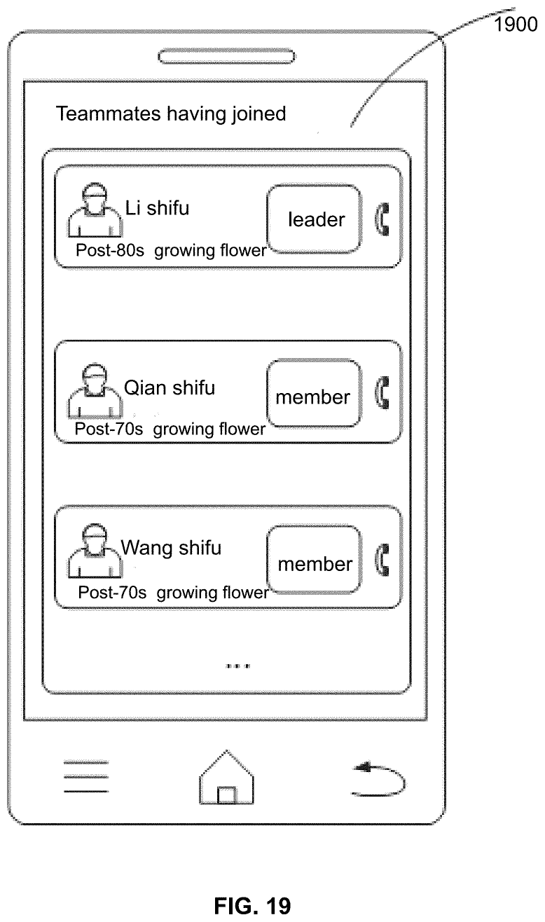

In some embodiments, the third interface may also be set a refresh button. When there is no suitable candidate team member, the user can click the refresh button, so that the terminal device may display other candidate team members. The third interface 1900 may be shown as FIG. 19. The user information of the team members that have accepted the invitation and agree to join the team is displayed in the form of a list, and an instant communication portal may also be provided. The user can click the portal to realize communication with the team members. In some embodiments, after a team member receives the invitation and agrees to join the team, the license plate number of the team member may also be obtained by the processing device 112. The team leader may determine that a team member joins the team by uploading the license plate number of the team member to the server.

In 1640, the processing device 112 may determine a count of the at least one team member that agrees to join the team. In 1645, in response to a determination that the count of the at least one team member that agrees to join the team is equal to or exceeds a predetermined value, the processing device 112 may generate a notification indicating the team has been formed successfully. In 1650, the processing device 112 may send the notification to each of the at least one team member. In 1655, the processing device 112 may cause the notification to be displayed on the third interface of the device of the at least one team member.

In some embodiments, the processing device 112 may encrypt the notification. The processing device 112 may further transmit the encrypted notification to the device of the team member. For example, the processing device 112 may encrypt the notification using a public key of the device of the team member. The device of the team member may decrypt the encrypted notification using a private key of the device of the team member. In some embodiments, the encrypted notification may include authentication information related to the team member and/or the device of the team member to authenticate the team member and/or the device of the team member.

In some embodiments, each of the teams may also be set a team name. After receiving the team name entered by the user on a team name setting interface, the device may send the team name to the server so that the server can identify the driver team according to the team name.

In 1660, when the registration instruction is a member registration instruction, the processing device 112 may cause the device to display a personal information setting interface and receive user information set by the user (e.g., a team member) through the personal information setting interface of the device of the user. The user information set by the user may include behavior habit information and natural attribute information. In some embodiments, some labels may also be provided on the personal information setting interface for users to choose, such as post-70s, post-80s, keeping birds, playing mahjong, growing flowers, fighting landlords, climbing, and so on. The personal information setting interface in this step may be the same as or different from the personal information setting interface in step 1615. The user information of the team members may be used for the matching process. The user information of the team members may be displayed to the team leader when the team leader selects team members for the invitation, so that the team leader can decide whether to invite the team members.

In 1665, the processing device 112 may identify a team leader for the user based on the information of the user set by the user. In 1670, the processing device 112 may detect that a second invitation is received from the team leader and cause the second invitation to be displayed on a fourth interface of the device. The fourth interface can be an instant messaging interface or other types of communication interface.

In some embodiments, the second invitation from the team leader may be encrypted by the device of the team leader. The processing device 112 may decrypted the encrypted second invitation from the team leader after receiving the encrypted response from the team leader. Merely by way of example, the device of the team leader may encrypt the second invitation from the team leader using its private key and/or digitally sign the request. The processing device 112 may decrypt the second invitation from the team leader using a public key of the device. In some embodiments, the encrypted second invitation from the team leader may include authentication information related to the device of the team leader and/or the team leader, such as an identification of the team leader, a password inputted by the team leader, and/or a digital signature of the device of the team leader. The processing device 112 may verify the authentication information of the device of the team leader and/or the team leader before the decrypting.

Further, if the team leader accepts the invitation, the information of participants of the team and the user information of each participant may be displayed on a team participant interface. The team participants may also communicate through the instant communication interface.

In some embodiments, a user can exit the team before the team forms. For example, the device of the user may receive a quitting instruction input by the user, and send the quitting instruction to the server, so that the server may remove the user from the r team.

In some embodiments, during an activity period, a device of a user may receive a score query input by the user through a score query interface, send the score query to the server, receive a result sent from the server, and display the result on the score query interface.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, or the like, or any suitable combination of the foregoing.

Computer program code for carrying out operations for aspects of the present disclosure may be written in any combination of one or more programming languages, including an object oriented programming language such as Java, scala, smalltalk, eiffel, jADE, emerald, c++, c #, vB. NET, python, or the like, conventional procedural programming languages, such as the “C” programming language, visual Basic, Fortran 2003, Perl, COBOL 2002, PHP, ABAP, dynamic programming languages such as Python, ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of at least one of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

### STATEMENT OF INVENTION

1. A system configured to operate an online to offline service platform, comprising:

at least one storage medium including a set of instructions for determining a team;

at least one processor in communication with the at least one storage medium, wherein when executing the set of instructions, the at least one processor is directed to perform operations including:

obtaining information relating to each of a plurality of participants to be grouped, the plurality of participants including a plurality of team leaders and a plurality of team members; and

determining one or more teams by automatically allocating the plurality of team members to the plurality of team leaders based on the information relating to the plurality of participants, wherein each of the one or more teams includes a team leader and at least one team member.

2. The system of item 1, wherein to determine the one or more teams, the at least one processor is directed to additional operations including:

determining an acceptance probability between each of the plurality of team leaders and each of the plurality of team members based on the information relating to the plurality of participants;

determining a team recommendation scheme based on the acceptance probabilities using an optimization recommendation algorithm; and

determining the one or more teams based on the team recommendation scheme.

3. The system of item 2, wherein to determine the acceptance probability between each of the plurality of team leaders and each of the plurality of team members, the at least one processor is directed to perform additional operations including:

determining the acceptance probability between each of the plurality of team leaders and each of the plurality of team members based on the information relating to the plurality of participants using an acceptance probability model.

4. The system of item 3, wherein the acceptance probability model is determined based on historical team determination data relating to the plurality of team leaders and the plurality of team members.

5. The system of item 4, wherein the acceptance probability model is determined using a logistic regression algorithm.

6. The system of any one of items 2-5, wherein to determine the team recommendation scheme based on the acceptance probabilities using the optimization recommendation algorithm, the at least one processor is further directed to perform additional operations including:

determining an expected success probability of determining a team for each of one or more candidate team recommendation schemes; and

designating the candidate team recommendation scheme corresponding to the maximum expected success probability among the one or more candidate team recommendation schemes as the team recommendation scheme.

7. The system of any one of items 2-5, wherein to determine the team recommendation scheme based on the acceptance probabilities using the optimization recommendation algorithm, the at least one processor is further directed to perform additional operations including:

determining an expected success probability model for determining a team; and

determining the team recommendation scheme based on the expected success probability model using the optimization recommendation algorithm.

8. The system of any one of items 1-7, wherein to determine the one or more teams, the at least one processor is directed to perform additional operations including:

determining a matching value between each of the plurality of team leaders and each of the plurality of team members based on the information relating to the plurality of team leaders and the plurality of team members; and

determining the one or more teams based on the matching values.

9. The system of item 8, wherein to determine the matching value between each of the plurality of team leaders and each of the plurality of team members, the at least one processor is directed to perform additional operations including:

determining a similarity degree between the information of the each of the plurality of team leaders and the information of the each of the plurality of team members; and

determining the matching value between each of the plurality of team leaders and each of the plurality of team members based on the similarity degree between the information of the each of the plurality of team leaders and the information of the each of the plurality of team members.

10. The system of item 9, wherein the similarity degree includes a hometown similarity degree, an age similarity degree, and a character similarity degree.

11. The system of item 10, wherein the hometown similarity degree is determined based on a hometown evaluation function, the age similarity degree is determined based on an age evaluation function, and the character similarity degree is determined based on a character evaluation function.

12. The system of item 10 or 11, wherein to determine the matching value, the at least one processor is directed to perform additional operations including:

determining a first sub-matching value based on the hometown similarity degree;

determining a second sub-matching value based on the age similarity degree;

determining a third sub-matching value based on the character similarity degree; and

determining the matching value based on at least one of the first sub-matching value, the second sub-matching value, or the third sub-matching value.

13. The system of item 1, wherein to determine the one or more teams, the at least one processor is directed to perform additional operations including:

extracting evaluation information relating to the plurality of participants from the information relating to the plurality of participants to be grouped;

assigning, based on the evaluation information relating to each of the plurality of participants, each of the plurality of participants to a group; and

determining the one or more teams based on the group assignment relating to each of the plurality of participants.

14. The system of item 13, wherein to assign each of the plurality of participants to a group, the at least one processor is directed to perform additional operations including:

obtaining a classification model; and

determining the group assignment relating to each of the plurality of participants based on the evaluation information using the classification model.

15. The system of item 13 or 14, wherein the evaluation information relating to a participant of the plurality of participants includes evaluation information of the participant on the online to offline service platform.

16. The system of item 15, wherein the groups include a recommender group, a passive person group, and a detractor group, and to assign each of the plurality of participants to a group, the at least one processor is directed to perform additional operations including:

assigning the participant to the recommender group, the passive person group, or the detractor group based on the evaluation information of the participant on the online to offline service platform.

17. The system of item 13 or 14, wherein the evaluation information relating to a participant of the plurality of participants includes evaluation information that a service requestor provides regarding the participant.

18. The system of item 17, wherein the groups include a high-quality service group, a general-quality service group, and a poor-quality service group, and to assign each of the plurality of participants to a group, the at least one processor is directed to perform additional operations including:

assigning the participant to the high-quality service group, the general-quality service group, or the poor-quality service group based on the evaluation information that the service requestor provides regarding the participant.

19. The system of any one of items 13-18, wherein the at least one processor is directed to perform additional operations including:

organizing one or more participants belonging to different groups into a team.

20. The system of any one of items 13-18, wherein the at least one processor is directed to perform additional operations including:

organizing one or more participants belonging to a same group into a team.

21. The system of item 1, wherein to determine the one or more teams, the at least one processor is directed to perform additional operations including:

extracting historical order information relating to each of the plurality of participants from the information relating to the plurality of participants to be grouped;

determining a driving behavior characteristic for each of the plurality of participants based on the historical order information relating to the each participant;

dividing the plurality of participants into one or more driver groups based on the driving behavior characteristic of each of the plurality of participants; and

for each of the one or more driver groups, forming at least one team.

22. The system of item 21, wherein the driving behavior characteristic of a participant includes a working time of the participant or a driving region of the participant.

23. The system of item 21 or 22, wherein to divide the plurality of participants into one or more driver groups, the at least one processor is directed to perform additional operations including:

determining a driving behavior similarity degree between each pair of the plurality of participants; and

determining the one or more driver groups based on the driving behavior similarity degree between each pair of the plurality of participants.

24. The system of any one of items 21-23, wherein each of the driver group includes at least one team leader and at least one team member, and to form at least one team for each of the one or more driver groups, the at least one processor is directed to perform additional operations including:

for a driver group, sending information relating to the at least one team member of the driver group to the at least one team leader of the driver group;

receiving a response from the at least one team leader of the driver group with respect to each of the at least one team member of the driver group; and

determining the at least one team for the driver group based on the response from the at least one team leader of the driver group.

25. The system of item 24, wherein the information relating to the at least one team member and the response are encrypted, and the at least one processor is further directed to perform additional operations including:

decrypting the encrypted information relating to the at least one team member and decrypting the encrypted response.

26. The system of item 25, wherein to decrypt the encrypted information relating to the at least one team member, the at least one processor is further directed to perform additional operations including:

verifying authentication information of the at least one team member or a device of the at least one team member before the decrypting of the encrypted information, and

to decrypt the encrypted response, the at least one processor is further directed to perform additional operations including:

verifying authentication information of the at least one team leader or a device of the at least one team leader before the decrypting of the encrypted response.

27. The system of item 1, wherein the at least one processor is directed to perform additional operations including:

receiving a registration instruction via a first interface of a device of a participant of the plurality of the participants to be grouped;

determining a type of the registration instruction, wherein the type of the registration instruction includes a leader registration instruction or a member registration instruction; and

in response to a determination that the registration instruction is a leader registration instruction,
identifying, from the plurality of participants, one or more candidate team members;
causing user information relating to the one or more candidate team members to be displayed on a second interface of the device of the participant; and
receiving a selection of at least one of the one or more candidate team members from the device of the participant;
sending a first invitation for joining a team to each of the at least one selected candidate team member;
receiving one or more responses to the first invitation;
determining, based on the received responses, at least one team member that agrees to join the team; and
causing user information relating to the at least one team member that agrees to join the team to be displayed on a third interface of the device of the participant.

28. The system of item 27, wherein to determine one or more candidate team members, the at least one processor is directed to perform additional operations including:

causing the device to display a personal information setting interface;

receiving user information set by the participant through the personal information setting interface; and

determining the one or more candidate team members based on the user information set by the participant and the leader registration instruction.

29. The system of item 27 or 28, wherein the at least one processor is directed to perform additional operations including:

determining a count of the at least one team member that agrees to join the team; and

in response to a determination that the count of the at least one team member that agrees to join the team is equal to or exceeds a predetermined value,
generating a notification indicating the team has been formed successfully;
sending the notification to each of the at least one team member; and
causing the notification to be displayed on the third interface of the devices.

30. The system of item 29, wherein the at least one processor is further directed to perform additional operations including:

encrypting the notification; and

sending the encrypted notification to each of the at least one team member.

31. The system of item 30, wherein the encrypted notification sent to one of the at least one team member includes authentication information of the team member or the device of the team member to authenticate the team member or the device of the team member.

32. The system of item 27, wherein in response to a determination that the registration instruction is a member registration instruction, the at least one processor is directed to perform additional operations including:

causing the device to display a personal information setting interface;

receiving user information set by the participant through the personal information setting interface;

identifying, from the plurality of participants, a team leader for the participant based on the user information of the participant; and

detecting that a second invitation is received from the team leader; and

causing the second invitation to be displayed on a fourth interface of the device.

33. The system of item 32, wherein the second invitation is encrypted, and the at least one processor is further directed to perform additional operations including:

decrypting the encrypted second invitation.

34. The system of item 33, wherein to decrypt the encrypted second invitation, the at least one processor is further directed to perform additional operations including:

verifying authentication information of the team member or the device of the team member before the decrypting.

35. The system of any one of items 27-34, wherein the at least one processor is further directed to perform additional operations including:

causing activity information corresponding to the type of the registration instruction to be displayed on a fifth interface of the device, wherein the activity information includes at least one of responsibility information, task information, or reward information.

36. The system of any one of items 27-35, wherein the at least one processor is further directed to perform additional operations including:

encrypting the first invitation; and

sending the encrypted first invitation to each of the at least one selected candidate team member.

37. The system of item 36, wherein the encrypted first invitation sent to each of the at least one selected candidate team member includes authentication information of the each selected candidate team member or authentication information of a device of the each selected candidate team member to authenticate the each selected candidate team member or the device of the each selected candidate team member.

38. A method for operating an online to offline service platform implemented on a computing device having at least one processor and at least one storage medium including a set of instructions for determining a team, comprising:

obtaining information relating to each of a plurality of participants to be grouped, the plurality of participants including a plurality of team leaders and a plurality of team members; and

determining one or more teams by automatically allocating the plurality of team members to the plurality of team leaders based on the information relating to the plurality of participants, wherein each of the one or more teams includes a team leader and at least one team member.

39. The method of item 38, wherein the determining the one or more teams comprises:

determining an acceptance probability between each of the plurality of team leaders and each of the plurality of team members based on the information relating to the plurality of participants;

determining a team recommendation scheme based on the acceptance probabilities using an optimization recommendation algorithm; and

determining the one or more teams based on the team recommendation scheme.

40. The method of item 39, wherein the determining the acceptance probability between each of the plurality of team leaders and each of the plurality of team members comprises:

determining the acceptance probability between each of the plurality of team leaders and each of the plurality of team members based on the information relating to the plurality of participants using an acceptance probability model.

41. The method of item 40, wherein the acceptance probability model is determined based on historical team determination data relating to the plurality of team leaders and the plurality of team members.

42. The method of item 41, wherein the acceptance probability model is determined using a logistic regression algorithm.

43. The method of any one of items 39-42, wherein the determining the team recommendation scheme based on the acceptance probabilities using the optimization recommendation algorithm comprises:

determining an expected success probability of determining a team for each of one or more candidate team recommendation schemes; and

designating the candidate team recommendation scheme corresponding to the maximum expected success probability among the one or more candidate team recommendation schemes as the team recommendation scheme.

44. The method of any one of items 39-42, wherein the determining the team recommendation scheme based on the acceptance probabilities using the optimization recommendation algorithm comprises:

determining an expected success probability model for determining a team; and

determining the team recommendation scheme based on the expected success probability model using the optimization recommendation algorithm.

45. The method of any one of items 38-44, wherein the determining the one or more teams comprises:

determining a matching value between each of the plurality of team leaders and each of the plurality of team members based on the information relating to the plurality of team leaders and the plurality of team members; and

determining the one or more teams based on the matching values.

46. The method of item 45, wherein the determining the matching value between each of the plurality of team leaders and each of the plurality of team members comprises:

determining a similarity degree between the information of the each of the plurality of team leaders and the information of the each of the plurality of team members; and

determining the matching value between each of the plurality of team leaders and each of the plurality of team members based on the similarity degree between the information of the each of the plurality of team leaders and the information of the each of the plurality of team members.

47. The method of item 46, wherein the similarity degree includes a hometown similarity degree, an age similarity degree, and a character similarity degree.

48. The method of item 47, wherein the hometown similarity degree is determined based on a hometown evaluation function, the age similarity degree is determined based on an age evaluation function, and the character similarity degree is determined based on a character evaluation function.

49. The method of item 47 or 48, wherein the determining the matching value comprises:

determining a first sub-matching value based on the hometown similarity degree;

determining a second sub-matching value based on the age similarity degree;

determining a third sub-matching value based on the character similarity degree; and

determining the matching value based on at least one of the first sub-matching value, the second sub-matching value, or the third sub-matching value.

50. The method of item 38, wherein the determining the one or more teams comprises:

extracting evaluation information relating to the plurality of participants from the information relating to the plurality of participants to be grouped;

assigning, based on the evaluation information relating to each of the plurality of participants, each of the plurality of participants to a group; and

determining the one or more teams based on the group assignment relating to each of the plurality of participants.

51. The method of item 50, wherein the assigning each of the plurality of participants to a group comprises:

obtaining a classification model; and

determining the group assignment relating to each of the plurality of participants based on the evaluation information using the classification model.

52. The method of item 50 or 51, wherein the evaluation information relating to a participant of the plurality of participants includes evaluation information of the participant on the online to offline service platform.

53. The method of item 52, wherein the groups include a recommender group, a passive person group, and a detractor group, and to assign each of the plurality of participants to a group, and the method further comprises:

assigning the participant to the recommender group, the passive person group, or the detractor group based on the evaluation information of the participant on the online to offline service platform.

54. The method of item 50 or 51, wherein the evaluation information relating to a participant of the plurality of participants includes evaluation information that a service requestor provides regarding the participant.

55. The method of item 54, wherein the groups include a high-quality service group, a general-quality service group, and a poor-quality service group, and to assign each of the plurality of participants to a group, and the method further comprises:

assigning the participant to the high-quality service group, the general-quality service group, or the poor-quality service group based on the evaluation information that the service requestor provides regarding the participant.

56. The method of any one of items 50-55, wherein the method further comprises:

organizing one or more participants belonging to different groups into a team.

57. The method of any one of items 50-55, wherein the method further comprises:

organizing one or more participants belonging to a same group into a team.

58. The method of item 38, wherein the determining the one or more teams comprises:

extracting historical order information relating to each of the plurality of participants from the information relating to the plurality of participants to be grouped;

determining a driving behavior characteristic for each of the plurality of participants based on the historical order information relating to the each participant;

dividing the plurality of participants into one or more driver groups based on the driving behavior characteristic of each of the plurality of participants; and

for each of the one or more driver groups, forming at least one team.

59. The method of item 58, wherein the driving behavior characteristic of a participant includes a working time of the participant or a driving region of the participant.

60. The method of item 58 or 59, wherein the dividing the plurality of participants into one or more driver groups comprises:

determining a driving behavior similarity degree between each pair of the plurality of participants; and

determining the one or more driver groups based on the driving behavior similarity degree between each pair of the plurality of participants.

61. The method of any one of items 58-60, wherein each of the driver group includes at least one team leader and at least one team member, and the forming at least one team for each of the one or more driver groups comprises:

for a driver group,

sending information relating to the at least one team member of the driver group to the at least one team leader of the driver group;

receiving a response from the at least one team leader of the driver group with respect to each of the at least one team member of the driver group; and

determining the at least one team for the driver group based on the response from the at least one team leader of the driver group.

62. The method of item 61, wherein the information relating to the at least one team member and the response are encrypted, and method further comprises:

decrypting the encrypted information relating to the at least one team member and decrypting the encrypted response.

63. The method of item 62, wherein the decrypting the encrypted information relating to the at least one team member comprises:

verifying authentication information of the at least one team member or a device of the at least one team member before the decrypting of the encrypted information, and

the decrypting the encrypted response comprises:

verifying authentication information of the at least one team leader or a device of the at least one team leader before the decrypting of the encrypted response.

64. The method of item 38, wherein the method further comprises:

receiving a registration instruction via a first interface of a device of a participant of the plurality of the participants to be grouped;

determining a type of the registration instruction, wherein the type of the registration instruction includes a leader registration instruction or a member registration instruction; and

in response to a determination that the registration instruction is a leader registration instruction,
identifying, from the plurality of participants, one or more candidate team members;
causing user information relating to the one or more candidate team members to be displayed on a second interface of the device of the participant; and
receiving a selection of at least one of the one or more candidate team members from the device of the participant;
sending a first invitation for joining a team to each of the at least one selected candidate team member;
receiving one or more responses to the first invitation;
determining, based on the received responses, at least one team member that agrees to join the team; and
causing user information relating to the at least one team member that agrees to join the team to be displayed on a third interface of the device of the participant.

65. The method of item 64, wherein the identifying one or more candidate team members comprises:

causing the device to display a personal information setting interface;

receiving user information set by the participant through the personal information setting interface; and

determining the one or more candidate team members based on the user information set by the participant and the leader registration instruction.

66. The method of item 64 or 65, wherein the method further comprises:

determining a count of the at least one team member that agrees to join the team; and

in response to a determination that the count of the at least one team member that agrees to join the team is equal to or exceeds a predetermined value,
generating a notification indicating the team has been formed successfully;
sending the notification to each of the at least one team member; and
causing the notification to be displayed on the third interface of the devices.

67. The method of item 66, wherein the method further comprises:

encrypting the notification; and

sending the encrypted notification to each of the at least one team member.

68. The method of item 67, wherein the encrypted notification sent to a team member includes authentication information of the team member or the device of the team member to authenticate the team member or the device of the team member.

69. The method of item 64, wherein in response to a determination that the registration instruction is a member registration instruction, the method comprises:

causing the device to display a personal information setting interface;

receiving user information set by the participant through the personal information setting interface;

identifying, from the plurality of participants, a team leader for the participant based on the user information of the participant; and

detecting that a second invitation is received from the team leader; and

causing the second invitation to be displayed on a fourth interface of the device.

70. The method of item 69, wherein the second invitation is encrypted, and the method further comprises:

decrypting the encrypted second invitation.

71. The method of item 70, wherein the decrypting the encrypted second invitation comprises:

verifying authentication information of the team member or a device of the team member before the decrypting.

72. The method of any one of items 64-71, wherein the method further comprises:

causing activity information corresponding to the type of the registration instruction to be displayed on a fifth interface of the device, wherein the activity information includes at least one of responsibility information, task information, or reward information.

73. The method of any one of items 64-72, wherein the method further comprises:

encrypting the first invitation; and

sending the encrypted first invitation to each of the at least one selected candidate team member.

74. The method of item 73, wherein the encrypted first invitation sent to each of the at least one selected candidate team member includes authentication information of the each selected candidate team member or authentication information of a device of the each selected candidate team member to authenticate the each selected candidate team member or the device of the each selected candidate team member.

75. A non-transitory computer-readable storage medium embodying a computer program product, the computer program product comprising instructions configured to cause a computing device to:

obtain information relating to each of a plurality of participants to be grouped, the plurality of participants including a plurality of team leaders and a plurality of team members; and

determine one or more teams by automatically allocating the plurality of team members to the plurality of team leaders based on the information relating to the plurality of participants, wherein each of the one or more teams includes a team leader and at least one team member.

1. A method for determining a team, comprising:
determining acceptance probabilities between a plurality of team leaders and a plurality of team members based on information relating to the plurality of team leaders and information relating to the plurality of team members;
determining a team recommendation scheme based on the acceptance probabilities using an optimization recommendation algorithm; and
determining one or more teams based on the team recommendation scheme.

2. The method of claim 1, wherein the information relating to the plurality of team leaders and the information relating to the plurality of team members includes at least one of natural attribute information, social attribute information, or habitual attribute information.

3. The method of claim 1, wherein the determining the acceptance probabilities between the plurality of team leaders and the plurality of team members comprises:
determining the acceptance probabilities between the plurality of team leaders and the plurality of team members based on an acceptance probability model.

4. The method of claim 3, wherein the acceptance probability model is determined based on historical team determination data.

5. The method of claim 1, wherein the determining the acceptance probabilities between the plurality of team leaders and the plurality of team members comprises:
determining an acceptance probability between each of the plurality of team leaders and each of the plurality of team members.

6. The method of claim 5, wherein the determining the team recommendation scheme using the optimization recommendation algorithm comprises:
determining an expected success rate for team formation for each of candidate team recommendation schemes; and
designating a team recommendation scheme corresponding to the highest expected success rate as the team recommendation scheme.

7. The method of claim 1, wherein the determining the team recommendation scheme using the optimization recommendation algorithm comprises:
determining a success rate expectation model; and
determining the team recommendation scheme based on the success rate expectation model using the optimization recommendation algorithm.

8. The method of claim 1, wherein the determining the team recommendation scheme using the optimization recommendation algorithm comprises:
determining a sum of probabilities of successful team formation for each of different states of acceptance intention; and
determining a candidate team recommendation scheme corresponding to the maximum sum as the team recommendation scheme,
wherein the states of acceptance intention include a state of acceptance intention between each of the plurality of team leader and each of the plurality of team members.

9-14. (canceled)

15. A method for determining a team, comprising:
determining matching values between team participants based on information of the team participants to be grouped; and
determining one or more teams for the team participants based on the matching values.

16. The method of claim 15, wherein the determining the matching values between the team participants based on the information of the team participants to be grouped comprises:
determining the matching values between the team participants based on a similarity degree between the information of each pair of team participants.

17. The method of claim 16, wherein the larger the similarity degree between the information of each pair of the team participants is, the larger the matching values between each pair of the team participants is.

18. The method of claim 16, wherein the determining the matching values between the team participants based on the similarity degree between the information of each pair of the team participants comprises:
determining a matching value of each pair of the team participants based on at least one of a first component, a second component, or a third component of the matching value, wherein
the first component is determined based on a similarity degree between the hometown information of each pair of the team participants,
the second component is determined based on a similarity degree between the age information of each pair of the team participants, and
the third component is determined based on a similarity degree between the character information of each pair of the team participants.

19. The method of claim 15, wherein the team participants to be grouped include team leaders and team members, and the determining the matching values between the team participants based on the information of the team participants comprises:
determining a matching value between each of the team leaders and each of the team members based on information of the team leaders and information of the team members.

20. The method of claim 19, wherein the determining the matching value between each of the team leaders and each of the team members based on the information of the team leaders and the information of the team members comprises:
determining the matching value between each of the team leaders and each of the team members using an evaluation function.

21. The method of claim 15, wherein the determining one or more teams for the team participants based on the matching values comprises:
dividing the team participants into at least one team based on the matching values between the team participants, each of the at least one team corresponding to a total matching value, wherein at least one team has the maximum total matching value and the total matching value of each of the at least one team indicates the value of the sum of matching values between the team participants in the each team.

22. The method of claim 21, wherein each team includes a team leader and a plurality of team members, and the total matching value of the team is a sum of matching values between the team leader and each of the plurality of team members.

23-45. (canceled)

46. The method for determining a team for drivers based on driving behaviors of the drivers, comprising:
obtaining historical order information relating to each of a plurality of drivers, wherein the historical order information includes at least one of information relating to the drivers, order accepting times, or order accepting locations;
determining a driving behavior characteristic for each of the plurality of drivers based on the historical order information;
dividing the plurality of drivers into at least two driver groups based on the driving behavior characteristic of each of the plurality of drivers; and
for each of the at least two driver groups, forming at least one team.

47. The method of claim 46, wherein the determining a driving behavior characteristic for each of the plurality of drivers based on the historical order information comprises:
determining a characteristic of working time and/or a characteristic of driving region of each of the plurality of drivers based on the historical order information, wherein
the characteristic of working time includes distribution information of the order accepting times in at least one first preset time period, and/or distribution information of the order accepting times in at least one second preset time period within one week, and
the characteristic of driving region includes distribution information of the order accepting locations in at least one preset area within a preset geographical area.

48. The method of claim 46, wherein the dividing the plurality of drivers into at least two driver groups based on the driving behavior characteristic of each of the plurality of drivers comprises:
determining a similarity of driving behaviors between each pair of the plurality of drivers based on the driving behavior characteristic of each of the plurality of drivers; and
dividing the plurality of drivers into the at least two driver groups based on the similarity of driving behaviors between each pair of the plurality of drivers.

49. The method of claim 46, wherein the forming at least one team for each of the at least two driver groups comprises:
obtaining a role of each driver of each driver group, the role of each driver including a team leader or a team member;
sending information of team members in a driver group to a team leader in the driver group to request that the team leader provides a feedback indicating whether the team members are allowed to join a team of the team leader, the result including an team leader identification and team members identifications of team members that have joined the team;
receiving the result fed back by the team leader; and
assigning the team members whose identifications are in the result to the team of the team member corresponding to the team leader identification.

50-61. (canceled)
